(19) United States
(12) Patent Application Publication
(10) Pub. No.: US 2013/0103368 A1
(43) Pub. Date: Apr. 25, 2013

(54) Automated Experimental Design For Polymerase Chain Reaction

(71) Applicants: John Lyn Farmer, Santa Maria, CA (US); Robert Allan McCone, Orcutt, CA (US)

(72) Inventors: John Lyn Farmer, Santa Maria, CA (US); Robert Allan McCone, Orcutt, CA (US)

(21) Appl. No.: 13/281,320

(22) Filed: Oct. 25, 2011

(51) Int. Cl. G06F 7/60; G06F 17/10

(52) U.S. Cl. 703/2

(57) ABSTRACT

A method and apparatus of a device that generates a primer pair design to amplify a template in a DNA strand is described. The device calculates a first and second plurality of primers, where each primer in the first plurality of primers is from a different region of the DNA template than each primer in the second plurality of primers. The device further calculates a set of primer pairs, where each of primer pairs include one of the primers from the first plurality of primers and one primer from the second plurality of primers, and each of the first plurality of primer pairs is calculated based on a penalty of combination between the two primers in that primer pair.

### FIELD OF INVENTION

This invention relates generally to automated experimental design and more particularly to automated experimental design of a modification of a target DNA strand.

### BACKGROUND OF THE INVENTION

Scientists today rely on many tools and methods such as Basic Local Alignment Search Tool (BLAST), Nearest Neighbor Thermodynamics, primary and secondary structure prediction of nucleotide polymers, restriction enzymes, and knowledge of organism specific homologous recombination rates are just a few examples of techniques that are used in genetic experimentation.

Science is deeply rooted in experimentation. Experiments are to be tested and confirmed before products can be brought to market. For example, insulin is commonly produced by growing a biological precursor to insulin in bacteria. In addition, scientists will conduct many experiments before a process is developed, peer-reviewed, and perfected.

Genetic engineering is no exception to this procedure: whether it is new drug development, curing diseases with gene therapy, modifying enzymes to destroy pollutants, or genetically modifying rice to reduce vitamin A-deficiency in the developing world, genetic engineering generally follows this path:
1. Identify a piece of genetic material that a scientist wants to modify or study (DNA/RNA, etc.)
2. Create an experimental design that will yield a novel nucleotide sequence
3. Order enzymes, primers, and other consumables needed to conduct the experiment
4. Run the experimental design to create your novel nucleotide sequence
5. Insert this modified genetic material into an organism
6. Clone and grow your organism to maturity

Step 2 of this process is traditionally a tedious, heuristically driven, and error-prone process. A scientist is faced with trillions of combinations when creating an experimental design and often uses heuristics, best guesses, or intuition to create an experimental design. The end result can be a failed experiment, low yield, lost time, and/or lost money. This need not be the case, as there is a large amount of experimental understanding behind the process. However, not only is it very difficult for a human to account for most of the design parameters, it can be cost prohibitive for a scientist to master this niche field of knowledge. The scientist needs to work at a higher level in the process.

The heart of experimental design from step 2 above, lies in the selection of six “primers.” A primer is a small piece of genetic material that corresponds to an underlying genetic region but which also may have added sequences corresponding to restriction enzyme sequences or other alterations. Primers act to amplify specific regions of DNA and restriction enzymes act to cut specific regions of DNA. Combining specific amplified regions of DNA, carefully selected restriction enzymes, and other enzymes such as ligases, these things can act together as molecular scissors and glue for inserting and/or removing genetic material in vitro as well as in vivo.

A scientist will select from thousands of possible enzymes, thousands of possible individual primer solutions, and millions of individual primer-pair solutions when designing an experiment. Each of these primer choices is further subject to various experimental parameters (DNA concentration, salt concentration, melting temperature range, annealing properties, PCR programs, polymerases, etc.). However, there can be are literally trillions of possible six-primer solutions. Manually creating a simple error-free solution is difficult, tedious work. Manually selecting the best possible solution out of trillions of possibilities is very trying.

In addition to designing a six-primer solution, the scientist can design a reaction to make copies of the modified DNA. This is achieved today through the use of the Polymerase Chain Reaction (PCR). In order to amplify a region of DNA, a scientist needs some amount of that DNA which has the region of interest somewhere in that DNA (which is called the template) and two pieces of short strips of DNA called primers. The reaction occurs in a solution of buffers and enzymes.

A thermocycler holds small tubes where the reaction takes place, and is programmed to cycle rapidly and accurately through a series of timed temperature changes. The times and temperatures of the cycles are dependent upon properties of the template, primers, and reaction reagents and concentrations. A PCR program not optimized for a particular reaction could lead to a failed attempt at amplifying the desired region, or amplifying many unwanted regions.

### SUMMARY OF THE DESCRIPTION

A method and apparatus of a device that generates a primer pair design to amplify a template in a DNA strand is described. The device calculates a first and second plurality of primers, where each primer in the first plurality of primers is from a different region of the DNA template than each primer in the second plurality of primers. The device further calculates a set of primer pairs, where each of primer pairs include one primer from the first plurality of primers and one primer from the second plurality of primers, and each of the first plurality of primer pairs is calculated based on a penalty of combination between the two primers in that primer pair.

In another embodiment, a method and apparatus of a device that performs automated experimental design is described. The device receives a primer parameter input that is used to perform the automated experimental design. In addition, the device determines a plurality of possible primers. The device further calculates a set of six or more from the plurality of possible primers by calculating individual primer penalties for each primer in the set of six or more and inter-primer penalties between pairs of primers in the set of six or more using the primer input. In this embodiment, the set of six or more are designed to amplify a target in the DNA sequence.

In a further embodiment, a method and apparatus of a device that calculates a primer-enzyme combination is described. In one embodiment, the device receives primer input for the primer. In addition, the device receives an enzyme input sequence, wherein the enzyme input sequence is a sequence of nucleotide symbols and at least one of the nucleotide symbols is an ambiguity code. The device further calculates the primer using the primer input. Furthermore, the device calculates the enzyme that corresponds to the primer using the enzyme input sequence and the primer. In this embodiment, the calculated enzyme is the nucleotide sequence of the enzyme input with the ambiguity code is replaced by a non-ambiguous code.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1A is a block diagram of one embodiment of a DNA system that is to be modified.

FIG. 1B is a block diagram of one embodiment of a DNA system that includes a template to be modified using a plasmid.

FIG. 1C is a block diagram of a system to perform automated experimental design.

FIG. 2 is a flow diagram of one embodiment of a process to use automated experimental design in designing an experiment.

FIG. 3 is a flow diagram of one embodiment of a process to perform automated experimental design.

FIG. 4 is a flow diagram of one embodiment of a process to perform static enzyme optimization in order to rank six primer solutions.

FIG. 5A is a flow diagram of one embodiment of a process to use a best of the worst algorithm to generate a number of acceptable solutions for the primer range.

FIG. 5B is an illustration of different types of secondary structure 550A-E.

FIG. 6 is a flow diagram of one embodiment of a process to generate a primer.

FIG. 7 is a flow diagram of one embodiment of a process to perform wildcard enzyme optimization in order to rank six primer solutions.

FIG. 8A is a block diagram of one embodiment of a dynamic programming approach for solving a six primer degenerate primer mesh.

FIG. 8B is a block diagram of one embodiment of a dynamic programming approach that builds a series of degenerate primer meshes for primers P2-P5.

FIG. 9 is a flow diagram of one embodiment of a process to determine a quad-primer solution.

FIG. 10 is a flow diagram of one embodiment of a process to build a degenerate mesh.

FIG. 11 is a flow diagram of one embodiment of a process to build degenerates.

FIG. 12A is a flow diagram of one embodiment of a process to add a wildcard enzyme to a primer.

FIG. 12B is a block diagram of one embodiment of a wildcard enzyme.

FIG. 12C is a flow diagram of one embodiment of a process to filter a primer based on input primer characteristics.

FIG. 13 is a block diagram of a user interface to perform automated experimental design.

FIG. 14 is a block diagram of a primary criteria tab to input primary criteria parameters used for automated experimental design.

FIG. 15 is a block diagram of a primary heuristics tab to input primary heuristic parameters used for automated experimental design.

FIG. 16 is a block diagram of a primary quality tab to input primary quality parameters used for automated experimental design.

FIG. 17 is a block diagram of a southern option tab to input southern option parameters used for automated experimental design.

FIG. 18 is a block diagram of a user interface that outputs vector design results.

FIG. 19 is a flow diagram of one embodiment of a process to perform a PCR program.

FIG. 20 is a flow diagram of one embodiment of a process to generate PCR parameters for the PCR program.

FIG. 21 is a block diagram of one embodiment of an experiment module to perform automated experimental design in designing an experiment.

FIG. 22 is a block diagram of one embodiment of an automated experimental design module to perform automated experimental design.

FIG. 23 is a block diagram of one embodiment of a static enzyme optimization module to perform static enzyme optimization in order to rank six primer solutions.

FIG. 24 is a block diagram of one embodiment of a best of the worst module to use a best of the worst algorithm to generate a number of acceptable solutions for the primer range.

FIG. 25 is a block diagram of one embodiment of a primer generation module to generate a primer.

FIG. 26 is a block diagram of one embodiment of a wildcard enzyme optimization module to perform wildcard enzyme optimization in order to rank six primer solutions.

FIG. 27 is a block diagram of one embodiment of a quad primer module to determine a quad-primer solution.

FIG. 28 is a block diagram of one embodiment of a degenerate mesh module to build a degenerate mesh.

FIG. 29 is a block diagram of one embodiment of a degenerate module to build degenerates.

FIG. 30A is a block diagram of one embodiment of a primer filter module to filter a degenerate primer.

FIG. 30B is a block diagram of one embodiment of a primer filter module to filter a primer based on input primer characteristics.

FIG. 31 is a block diagram of one embodiment of a PCR protocol generation module to generate PCR parameters for the PCR program.

FIG. 32 illustrates one example of a typical computer system, which may be used in conjunction with the embodiments described herein.

FIG. 33 shows an example of a data processing system, which may be used with one embodiment of the present invention.

### DETAILED DESCRIPTION

A method and apparatus of a device that generates a primer pair design to amplify a template in a DNA strand is described. In the following description, numerous specific details are set forth to provide a thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that generates a primer pair design to amplify a template in a DNA strand is described. In one embodiment, a scientist uses the device to design a set of primers that can be used to amplify a region of interest in a DNA strand. In one embodiment, a scientist may use this automated design process to further tune the results for yield, price, on-hand consumable inventory, or other possible consumable solutions by specifying additional information a priority or applying this filtering information once the invention has returned a series of possible solutions.

For example and in one embodiment, a scientist uses the automated experimental design process to use a specific enzyme in an experiment but avoid low yields due to secondary binding. Sending this preference to the invention will result in a set of six or more that have the lowest possible hairpin, homodimer, heterodimer, and/or other types of secondary binding, while still ensuring the experiment can be run with the chosen enzyme.

As another example and embodiment, a scientist may use enzymes that are on hand due to tight budget, a tight deadline, or other constraint. The automated experimental design process returns results for possible experimental design solutions for scientist's specified enzyme inventory.

In a further example and embodiment, a scientist may request a list of the inexpensive solutions or another scientist may request the best possible solution out of all known possible enzymes in the world. As with the previous examples, the automated experimental design process can filter these results based on yield, price, or other factors after the invention has been run.

### GLOSSARY

Listed below is a set of definition for terms used in the present specification:

Deoxyribonucleic Acid (DNA): A polymer present in living organisms, which carries genetic information.

Genetic Experiment (Hereafter referred to as Experiment): A gene targeting experiment is a six-step scientific process for constructing a novel genetic sequence in an organism. For example, modifying Bovine DNA to produce insulin-like proteins in their milk.

Experiment Design: The process of designing an Experiment Solution for a Genetic Experiment.

Experiment Solution: A series of optimized materials and methods for constructing a novel genetic sequence. Materials include but are not limited to primers, enzymes, buffers, and solutions. Methods include but are not limited to protocols for PCR, ligations, digestions, etc.

PCR Protocol: Includes a PCR protocol and reaction mixture concentrations (salt, buffers, cofactors, DNA and primer concentrations, etc.). The PCR protocol is a series of times and temperatures used in conjunction with a pair of primers to amplify a specific region of a DNA template.

PCR (Polymerase Chain Reaction): A scientific technique used in molecular biology to make many copies (millions or billions) of a particular DNA region.

Nucleotide: Nucleotides are molecules that, when joined together, make up the structural units of DNA. Nucleotides can be purine bases or pyrimidines. In DNA, the purine bases are adenine (A) and guanine (G), while the pyrimidines are thymine (T) and cytosine (C).

Primer: A short, specific sequence of consecutive nucleotides. Primers are usually between 12-35 nucleotides long.

Primer Pair: Two primers, a forward and reverse primer that are used in PCR to amplify a specific region of a DNA template.

Forward Primer: A primer that occurs on the sense strand of DNA.

Reverse Primer: A primer that occurs on the anti-sense strand of DNA.

Sense Strand: There are two strands to a DNA double-helix. One strand is designated as the sense strand and the other strand is designated as the anti-sense strand. The sense strand is what encodes a gene.

Anti-Sense Strand: There are two strands to a DNA double-helix. One strand is designated as the sense strand and the other strand is designated as the anti-sense strand.

Restriction Enzyme (Hereafter referred to as Enzyme): A restriction enzyme (also known as a restriction endonuclease) is a type II restriction enzyme that cuts double-stranded DNA at a specific DNA sequence in a specific way. For example, the EcoRI restriction enzyme cuts the nucleotide sequence GAATTC between the G and the A.

Template: A region of DNA that a scientist wants to amplify with PCR.

Region of Interest: A specific region of DNA that a scientist wants to study or modify.

Flanking Region: The regions immediately before and after the region of interest.

Insert: A specific DNA sequence used to replace a region of interest. The Insert is usually contained within a plasmid.

Plasmid: A circular piece of DNA used by scientists to store novel DNA strands, one of which is the insert.

Construct: The intermediate DNA product of a genetic experiment. The construct is formed by ligating the insert with the flanking regions of the region of interest.

Sequence: Nucleotides arranged in a specific order.

Binding: The Watson-Crick pairing of one or more nucleotides.

Base Pair: An instance of one nucleotide binding to its Watson-Crick complement.

Nucleotide: Nucleotides are molecules that, when joined together, make up the structural units of RNA and DNA.

Secondary Structure: A set of base pairings in one or more single strands of DNA or RNA that results in the strand(s) forming complicated structures.

Hairpin: A secondary structure formed by the binding of a single strand of DNA to itself.

Homodimer: A secondary structure formed by the binding of a single strand of DNA to a copy of itself.

Heterodimer: A secondary structure formed by the binding of a single strand of DNA to a different strand of DNA.

Secondary Binding: During PCR, the binding of a primer to a region of the template DNA not intended by the scientist.

Dynamic Programming: Dynamic programming is a method of solving complex problems by breaking them down into simpler subproblems and combing the results of these subproblems into an overall solution. Dynamic programing makes it possible to solve exponentially complex problems in a realistic amount of time.

### Primer Design

In one embodiment, the method and apparatus automatically analyzes genetic experiment design solutions and produces one or more sets of six primer solutions for a given series of genetic material, a region of interest in this genetic material, a command to either insert or remove a piece of this genetic material, a list of enzymes to consider for this experiment, and a set of parameters for such things as DNA concentration, salt concentration, oligonucleotide length limits, melting temperature limits, GC % range, GC Clamp, self-dimer limits, cross-dimer limits, secondary binding limits, bulge options, stem/loop formation limits, 3′ annealing penalties, and other parameters typically associated with experimental design.

As described above, a scientist typically considers these parameters for each primer in a six-primer solution in designing the primer set. In addition, the scientist further considers interactions between the primers themselves. This can lead to trillions of possible combinations and an optimization problem that no human could ever hope to manually solve.

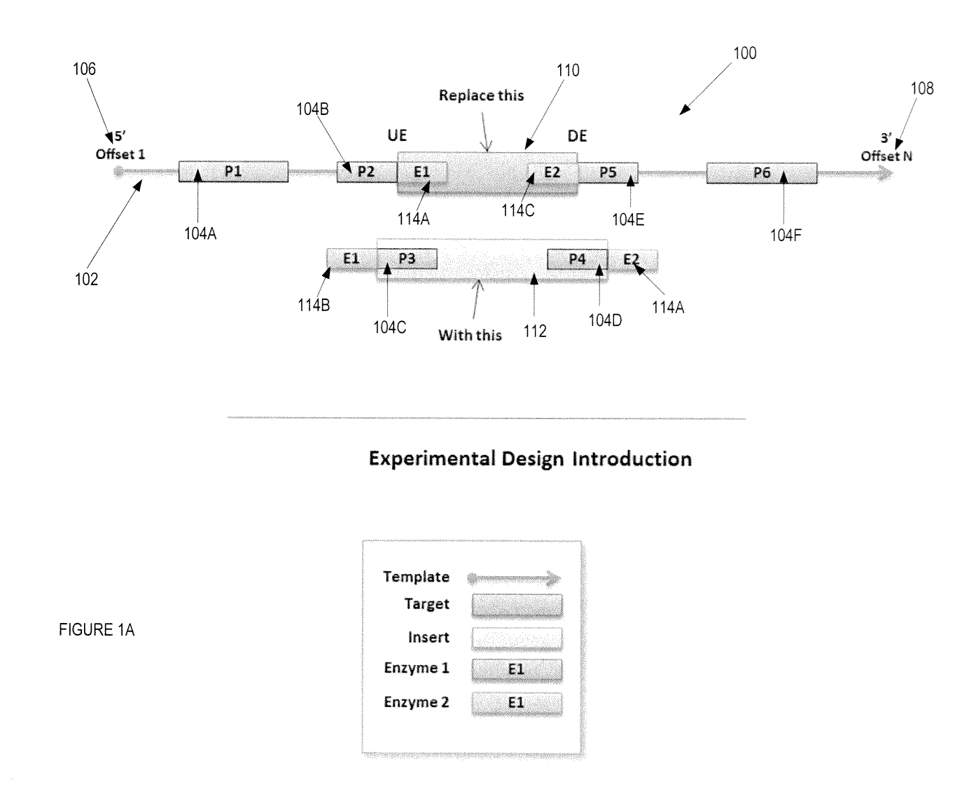

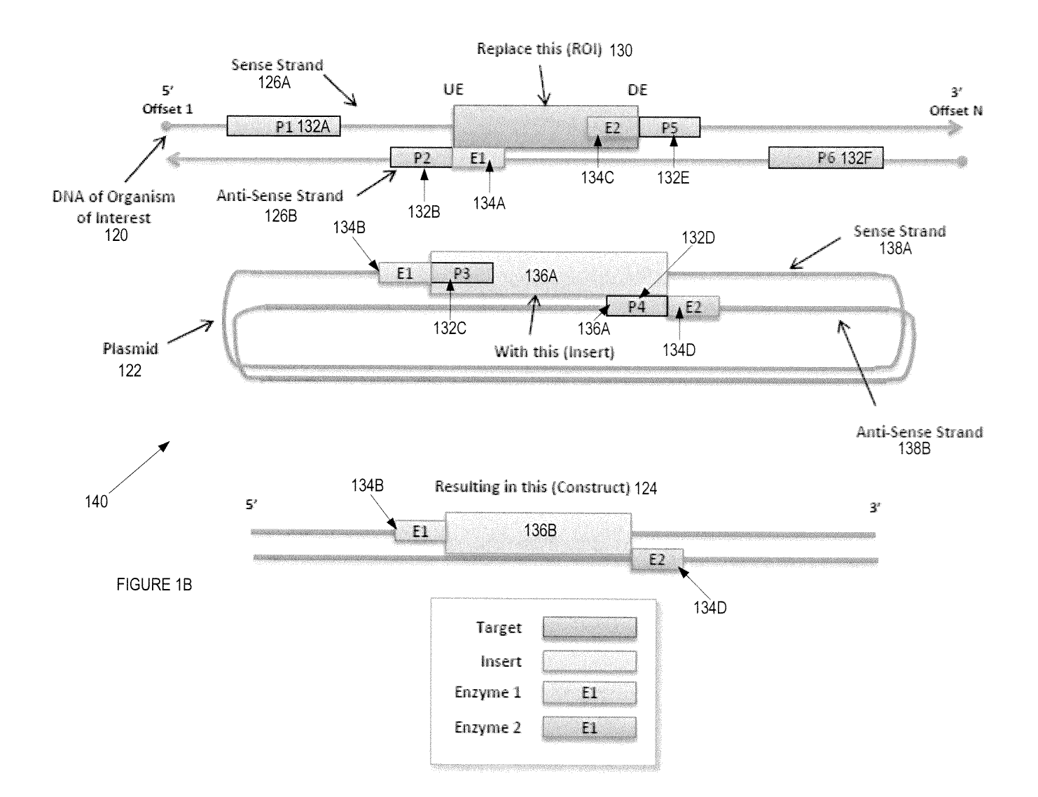

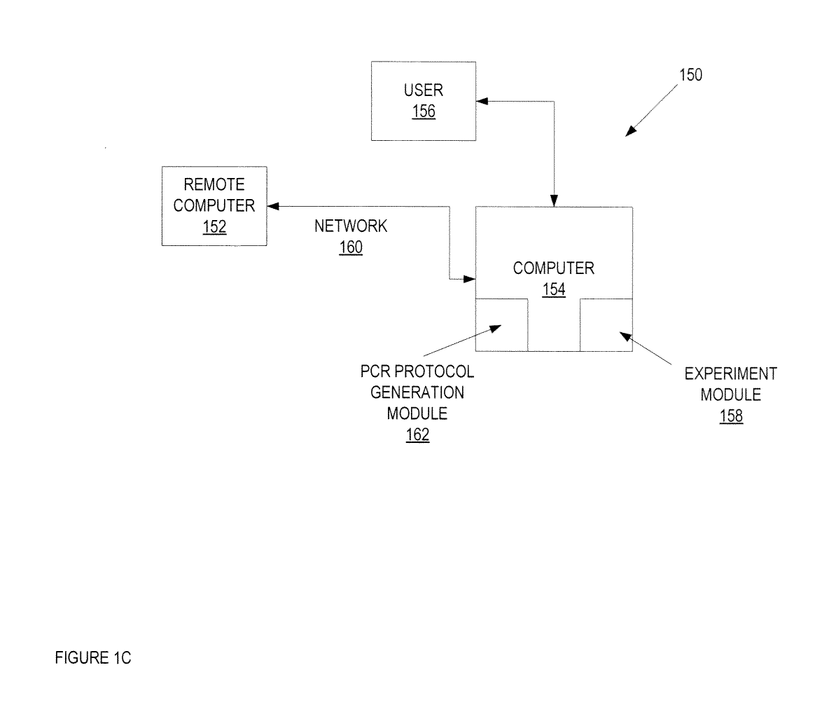

FIG. 1A is a block diagram of one embodiment of DNA system 100 that is to be modified. In FIG. 1A, the scientist wishes to replace a target 110 in the DNA system 100 with a construct 112. In one embodiment, the DNA system 100 comprises a template 102 that include a primer 1 (P1) 104A, primer 2 (P2) 104B, primer 3 (P3) 104C, primer 4 (P4) 104D, primer 5 (P5) 104E, and primer 6 (P6) 104F. As will be described further below, the DNA system 100 is composed of two different strands, a sense strand and an anti-sense strand. As described above, the sense strand is what encodes a gene and the anti-sense strand is used to bind to the sense strand, as well as allowing for replication of the genetic material and chemical protection. In this embodiment, the primer 104A-F will be on one or the other strands.

In one embodiment, template 102 is a sequence of nucleotides. In this embodiment, a scientist will typically want to modify some genetic material of the DNA system 100 as part of an experiment. The part of the genetic material that is to be modified is the target 110. The start 106 of the template 102 is the first nucleotide of the sequence and the end 108 is the last nucleotide in the sequence.

In one embodiment, the start 106 of the template 102 is called the 5′ side and the end 108 of the template 102 the 3′ side. A position in the template 102 that is closer to the start 106 of the template 102 is called “upstream” and a position that is closer to the end 108 of the sequence is called “downstream”.

In one embodiment, a scientist will modify a portion of the template 102 called the target 110. For example and in one embodiment, the scientist replaces the target 110 with some other genetic material called the insert 112. In another embodiment, the scientist removes the target 110.

In one embodiment, a scientist uses two enzymes and six primers to design a construct to remove the target 110. In this embodiment, both the enzymes and primers refer to specific DNA sequences. In one embodiment, part of the sequence of DNA is found on the template 110, and part of the other enzymes and primers are added. In one embodiment, enzymes sequences are 4 to 8 base pairs long (or longer), and overall primer sequences are generally between 12 and 35 base pairs long. As is known in the art, a base pair are two nucleotides on opposite complementary DNA or RNA strands that are connected via hydrogen bonds. For example and in one embodiment, in a DNA base pairing, adenine (A) forms a base pair with thymine (T) and guanine (G) forms a base pair with cytosine (C). In RNA, thymine is replaced by uracil (U). In one embodiment, the enzymes and primers are used as molecular scissors and glue to create a new genetic construct, which can be used to coerce the organism into replacing the target with the insert. In one embodiment, the enzyme sequences and/or primers sequences can be longer or shorter.

In one embodiment, each of the six primers 104A-F is located in separate “zones” in the diagram. For example and in one embodiment, P1 104A is an abbreviation that stands for the range that primer 1 can be located. Similarly, P2 104B, P3 104C, P4 104D, P5 104E, and P6 104F indicate areas of the template that the respective primer can be located in the template 102. In one embodiment, the P1 104A and P6 104F are relatively large and can be up to 500 nucleotide positions or long. On the other hand, the P2 104B, P3 104C, P4 104D, and P5 104E regions are relatively smaller and being in the range of 50 nucleotide positions or smaller.

FIG. 1B is a block diagram of one embodiment of a DNA system 140 that includes a DNA organism of interest 120 to be modified using a plasmid 122. FIG. 1B is similar to FIG. 1A in that FIG. 1B illustrates the DNA organism of interest 120 being modified with a plasmid 122 and a set of six primers 132A-F. FIG. 1B, however, further illustrates the details of this modification process. In FIG. 1B, the DNA organism of interest 120 includes two strands 126A-B, which are the sense strand 126A and the anti-sense strand 126B. As described above, the sense strand 126A is the strand that encodes a gene and the anti-sense strand 126B binds to the sense strand, as well as allowing for replication of the genetic material and chemical protection. In this embodiment, the P1 132A and P5 primers 132E are part of the sense strand 126A and the P2 132B and P6 132F primers are part of the anti-sense strand. Furthermore, each of the P2 132B and P5 132E primers have an enzyme sequence (134A and 134C, respectively) attached to these primers. In this embodiment, the enzyme sequence 134A is in the anti-sense strand 126B and opposite part of the target 130. Enzyme sequence 134C is part of the sense strand 126A and, additionally, part of the target 130.

In one embodiment, an enzyme sequence is a sequence of nucleotides that flank or are close to one of primers P2-P5 132B-E. In one embodiment, these enzyme sequences 134A and 134C are used to cuts double-stranded DNA at a specific DNA sequence in a specific way. In this embodiment, enzyme sequences 134A and 134C are enzymes as defined above. For example and in one embodiment, one or more of the enzyme sequences 132B-C can be the EcoRI restriction enzyme cuts the nucleotide sequence GAATTC between the G and the A. In one embodiment, the enzyme sequence-primer pairs (e.g., P2 132B—enzyme sequence E1 134A) flank the target 130 are used to cut the target 130 at a specific point. While in one embodiment, enzyme sequences 134A and 134B are a first enzyme sequence and enzyme sequences 134C-D are a second enzyme sequence, in alternate embodiments, these enzyme sequences 134A-D can be all the same, all different, and/or another combination.

In addition to the DNA Organism of Interest 120, the DNA system 140 also includes the plasmid 122 that is used to deliver the insert 136A to the DNA organism of interest 120. In one embodiment, the plasmid 122 includes a sense strand 138A and an anti-sense strand 138B. As described above, the sense strand 138A is the strand that encodes a gene and the anti-sense strand 138B binds to the sense strand, as well as allowing for replication of the genetic material and chemical protection. Similar to the DNA organism of interest 120, the plasmid 122 includes primer-enzyme pairs on different strands. In one embodiment, the plasmid 122 includes enzyme sequence E1 134B and primer P3 132C on the sense strand 136A. In one embodiment, the primer P3 132C is part of the insert 136A and the corresponding enzyme, enzyme sequence E1 134B is attached to the primer P3 132C. In another embodiment, the enzyme sequence E2 134D and primer P4 136A is part of the anti-sense strand 138B. In this embodiment, the primer P4 132D is located on the anti-sense strand 138B in a location that is opposite to the end of the insert 136A. Furthermore, enzyme sequence E2 134D is attached to primer P4 136A and is in a location that is outside of the insert 136A.

In one embodiment, the enzyme sequences 134A-D and primers 132A-F of FIG. 1B are used to create a construct 124 that can coerce the organism to cut out the target 130 and replace it with the insert 136A (e.g., homologous recombination). In one embodiment, the first enzyme sequence E1 134A-B is called the Upstream Enzyme (UE in the diagram) and the second enzyme sequence E2 134C-D is called the Downstream Enzyme (DE in the diagram). In this embodiment, enzyme sequences 134A-B are a first enzyme sequence and enzyme sequences 134C-D are a second enzyme sequence. In this embodiment, the Upstream Enzyme 134A-B works in conjunction with the P2 and P3 primers 132B-C while the Downstream Enzyme 134C-D works with the P4 and P5 primers 132D-E. In one embodiment, these four primers (P2, P3, P4, and P5) are known as “fixed” primers since there location is determined by the boundaries of the target region.

In one embodiment, the P1 132A and P6 132F primers are known as “floating” primers and can be located in a much larger range. In one embodiment, the range is normally less than 1000 nucleotides in length and is at least 500 nucleotides upstream from the start of the target and roughly the same distance upstream (P1) or downstream (P6) from the end of the target. In another embodiment, the floating primers can be of a shorter or longer number of nucleotides.

In one embodiment, a scientist uses various tools to find a primer in these ranges. For example and in one embodiment, the scientist can manually ensure that each primer is within a specific melting temperature range, the primer has a certain GC %, does not end with certain nucleotide combinations, and the primer does not fold on itself (hairpins), bind to another copy of itself (homo-dimerization), bind to other primers in the same test tube (hetero-dimerization), and doesn't bind to too many other areas of the template (secondary-binding). Furthermore, the scientist also considers several other primer parameters as he attempts to locate a sequence of DNA that is “ideal.” This is typically accomplished by visually inspecting the primer ranges for a “good primer” while using several different tools to calculate melting temperature, hairpin analysis, dimer analysis, etc.

Once a scientist has selected what looks like a good primer, the scientist repeats this process for each of the remaining five primers. In one embodiment, the primers are separated into pairs. The P1/P2 primers 132A-B are the upstream primers, the P3/P4 132C-D primers are the construct primers, and the P5/P6 132E-F primers are the downstream primers. In this embodiment, each of these primer pairs will be in a separate test tube so the scientist ensures that the melting temperature of each of the primer pairs is within a specific number of degrees of tolerance. In addition, the scientist ensures that these two primers will not bind to each other instead of the template (the hetero-dimerization previously mentioned).

If any of the primers or primer pairs fail to meet these criteria, the scientist must choose another primer and look for a better solution. If no valid primers are available, the scientist will choose a different enzyme and repeat the entire process.

This entire manual process, however, is error-prone and time consuming and is very easy to select a primer that initially looks good but results in a poor yield. Many scientists do not know if their design is bad or if their experiment was contaminated. Furthermore, it can sometimes take months or many failed experiments before reaching a good yield.

It would be useful to a scientist to automate the primer selection process so as to minimize the experimental difficulties involved with the manual determination of primer as described above in FIG. 1AB. FIG. 1C is a block diagram of a system 150 to perform automated experimental design of the primers. In FIG. 1C, system 150 includes a computer 154 that can perform the automated experimental design of the primer set. While in one embodiment, the computer 154 is used locally by a user 156 (such as the scientist), in another embodiment the automated experimental design is invoked by a remote computer 152 over a network 160. For example and in one embodiment, the remote computer 152 could invoke the automated experimental design via a web interface provided by computer 154 or another device.

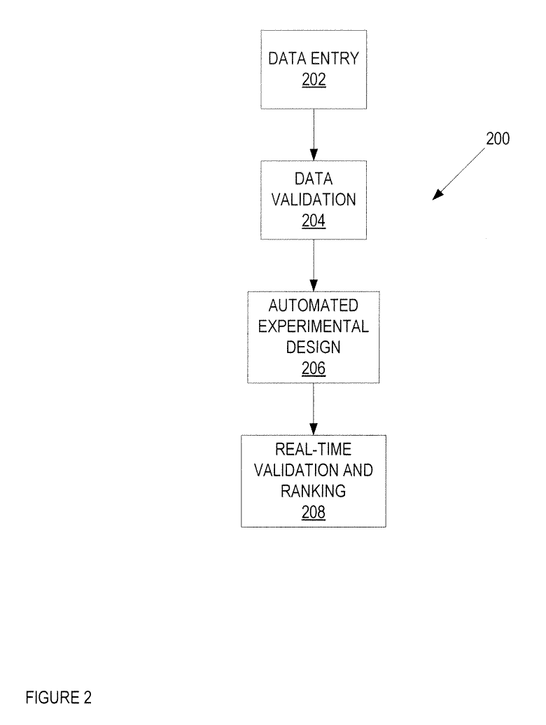

In one embodiment, the computer 154 includes experiment module 158 and Polymerase Chain Reaction (PCR) protocol generation module 162. In one embodiment, the experiment module 158 is a module that is used to perform automated experimental design to design a set of primers that can be used to replace a target with another nucleotide sequence. For example and in one embodiment, the experiment module 158 receives input parameters from a user, such as the DNA strand, target, insert, and primer parameters (specific melting temperature range, GC %, certain excluded nucleotide combinations, enzyme input, etc.). The experiment module 158 outputs a set of primers based on the input parameters. Furthermore, the experiment module 158 calculates the set of primers such that one or more primers do not fold on itself (hairpins), bind to itself (homo-dimerization), bind to other primers in the same test tube (hetero-dimerization), and does not bind to too many other areas of the template (secondary-binding). Furthermore, the process that calculates the set of primers used by the experiment module 158 is further described in FIGS. 2-12 below.

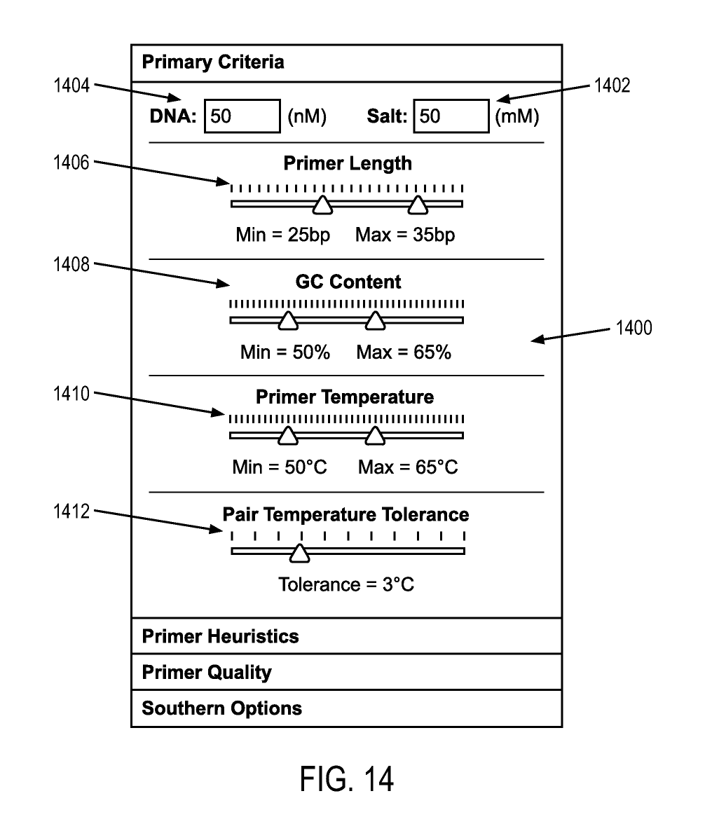

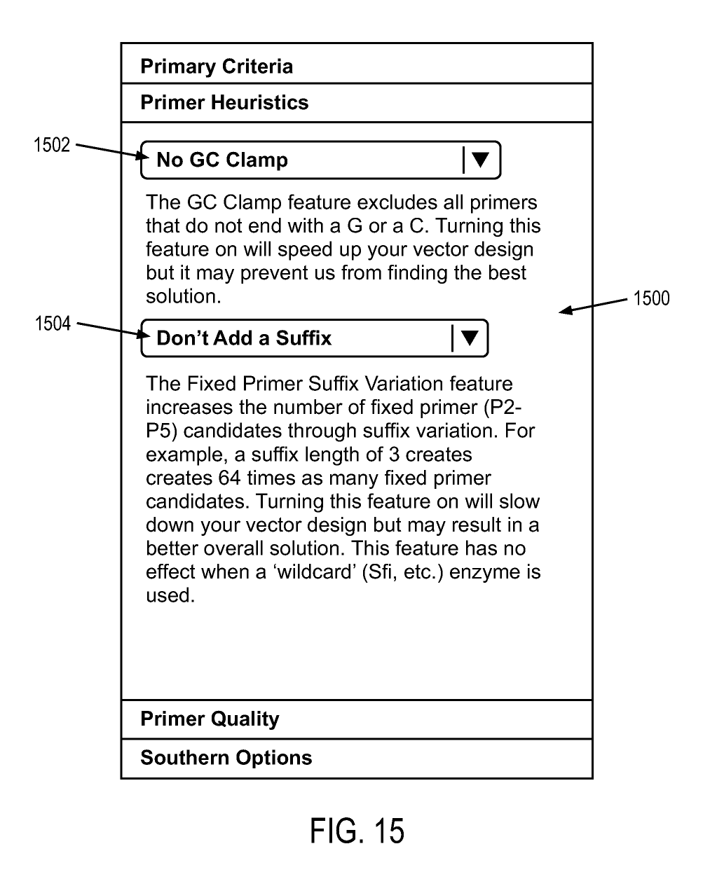

In one embodiment, the PCR protocol generation module 162 receives the primers calculated by the experiment module 158 and a template for each reaction needed (three total in our Automated Experimental Design, four if a scientist chooses verification) and designs a PCR Program (set of instructions for a thermocycler) that optimizes the chance of getting good and specific yield. The PCR protocol generation module 162 is further described in FIGS. 14 and 15.

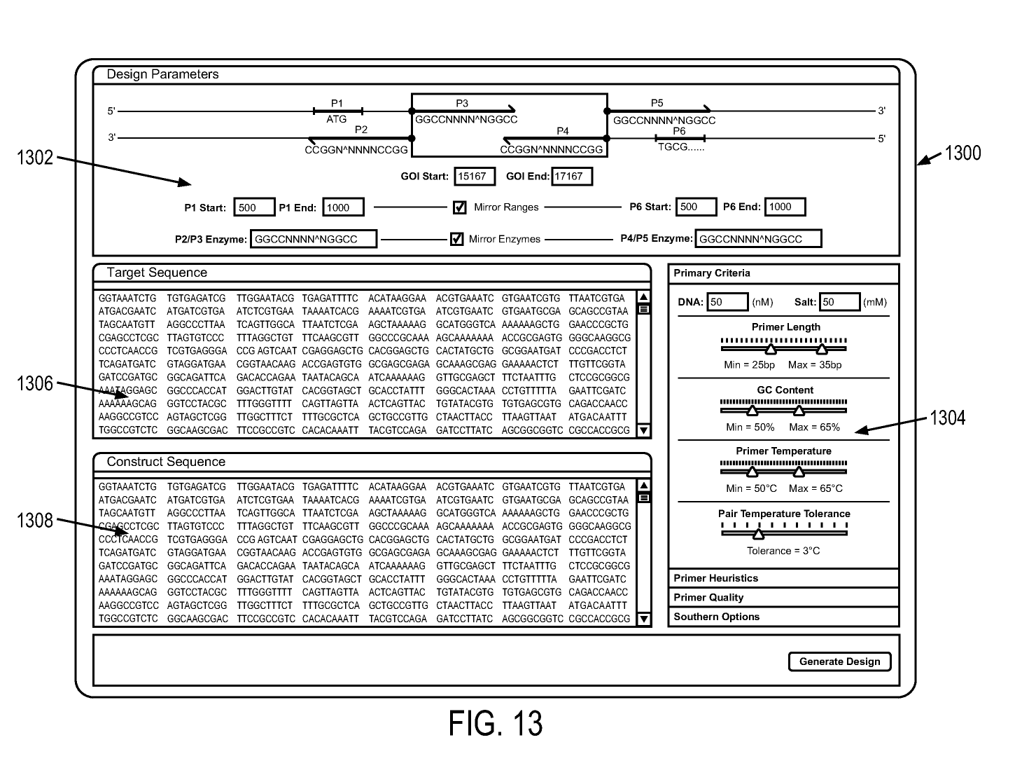

FIG. 2 is a flow diagram of one embodiment of a process 200 to use automated experimental design in designing an experiment. In one embodiment, the experiment module 158 of FIG. 1B above uses process 200 to automatically design a set of primers for a reaction. In FIG. 2, process 200 begins by receiving the input data for the automated experimental design at block 202. In one embodiment, process 200 receives DNA concentration, salt concentration, primer length range, GC Content percentage, primer melting temperature, GC Clamp indication, suffix indication, primer quality parameters (Repeats, Binds, Annealing Penalty Factor, etc.), enzyme constraints (upstream, downstream, wildcard, multi-enzyme, etc.) and southern option parameters. For example and in one embodiment, process 200 receives input data as illustrated in FIG. 13 described below.

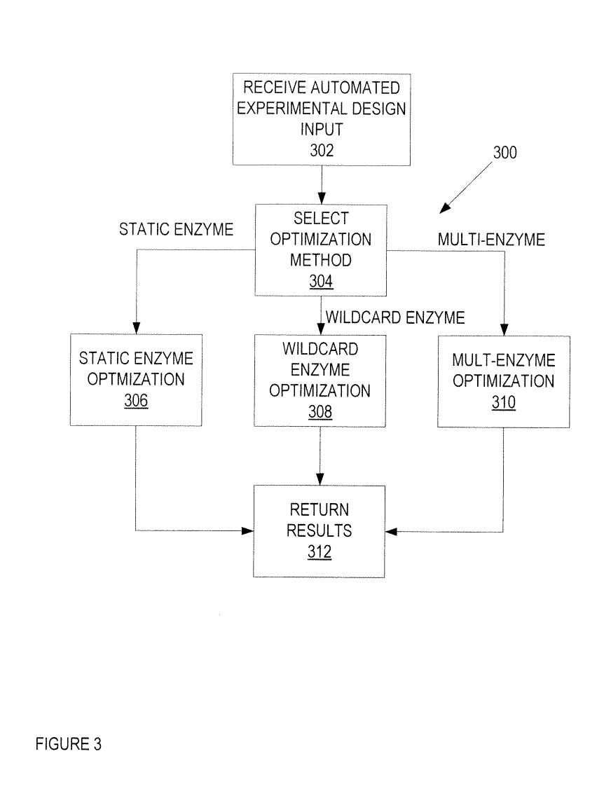

At block 204, process 200 validates the input data. In one embodiment, process 200 determines if the data is within a range that corresponds to the different input parameters. For example and in one embodiment, process 200 checks for illegal characters and/or characters that are outside the range expected for the corresponding input. Process 200 performs automated experimental design with the validated input data at block 206. In one embodiment, process 200 performs automated experimental design by optimizing the individual primers and primer sets based on the input data. Automated experimental design is further described in FIG. 3 below.

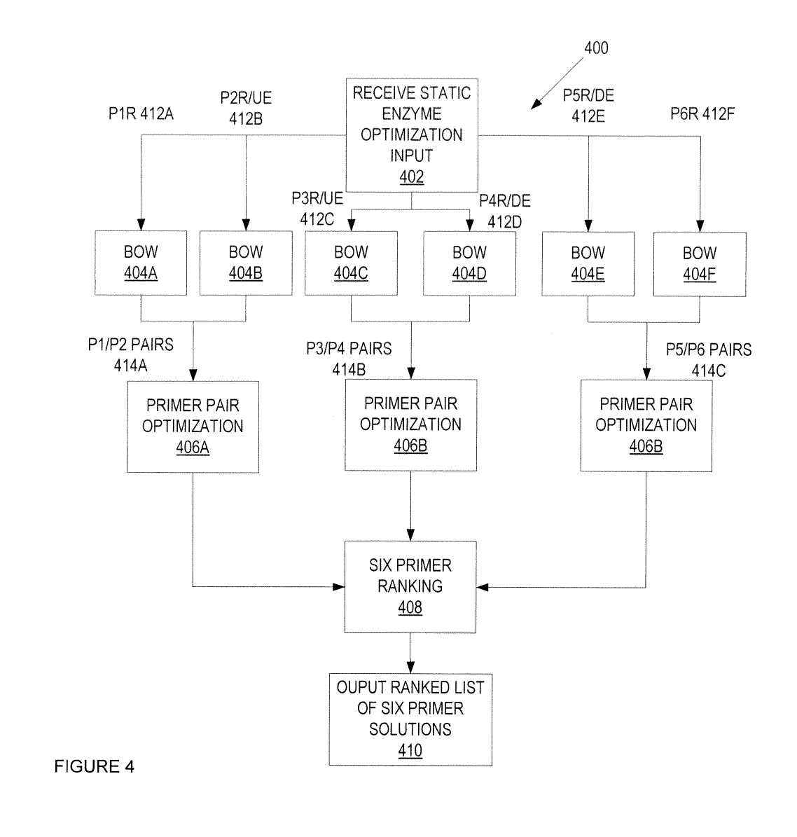

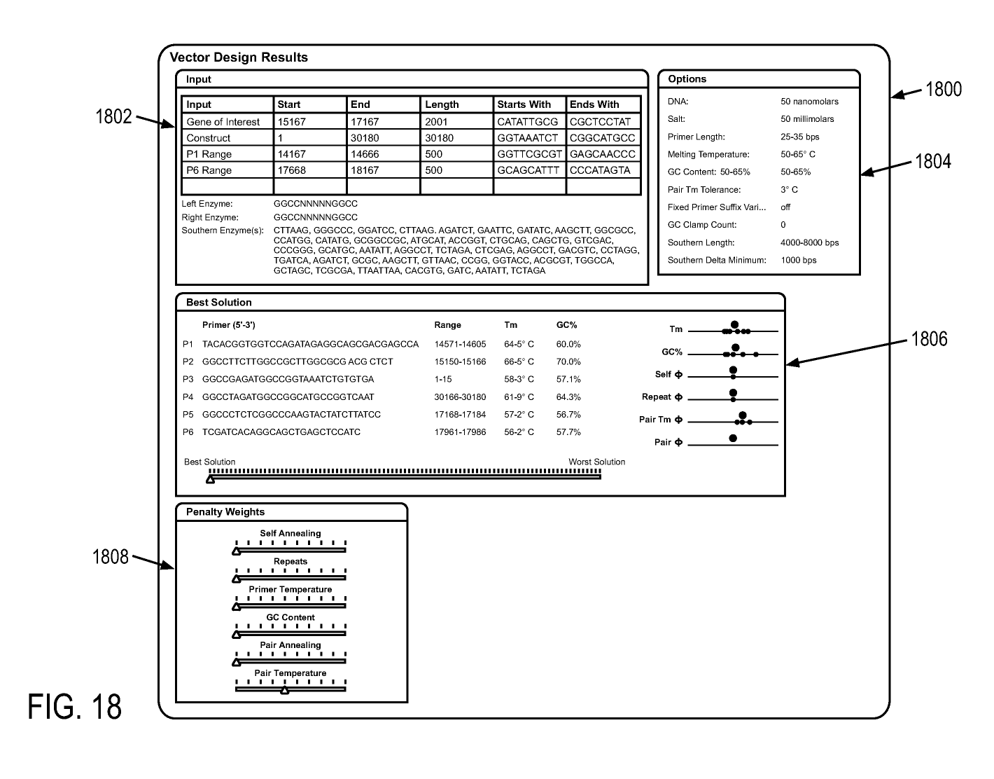

Process 200 validates and ranks the results of the automated experimental design at block 208. In one embodiment, process 200 filters the results and ranks the results. In one embodiment, the automated experiment design of block 206 can take minutes or hours to complete depending on the scientist's parameters. Real-time filtering and ranking lets a scientist eliminate possible solutions and view results in near-time. For example and in one embodiment, process 200 performs real-time filtering and ranking by receiving different penalty weights via a user interface, such as the penalty weights panel 1808 as illustrated in FIG. 18 below. In one embodiment, process 200 determines the primer sets based on penalties for the individual primers and one or more penalties between primer pairs. In this embodiment, process 200 weights each of these penalties to perform real-time filtering and ranking of the primer set results. The penalties are further described at FIG. 4 below.

For example and in one embodiment, suppose a scientist forgot to include a GC clamp when submitting a request. Instead of resubmitting the requests, and waiting for the result, the scientist could simply turn on a GC-clamp filter and view the valid solutions.

In one embodiment, a scientist may also want to change solution ranking by assigning weight(s) to one or more input parameters. For example and in one embodiment, a scientist may decide that melting temperature is more important than GC percentage and assign a higher weight to the melting temperature penalty. Process 200 recalculate the penalties in real-time without having to recalculate a new automated experimental design.

FIG. 3 is a flow diagram of one embodiment of a process 300 to perform automated experimental design. In one embodiment, process 300 is performed by process 200 at FIG. 2, block 206 above. Process 300 begins by selecting an optimization method at block 304. In one embodiment, process 300 can perform a static enzyme optimization, a wildcard enzyme optimization and/or a multi-enzyme optimization. In one embodiment, the optimization methods use dynamic programming to breakdown the optimization of the primer set by optimizing individual primers, optimizing pairs of primers using the optimized individual primers, and optimize a set of six primers using the optimized primer pairs. If the static enzyme optimization is request, at block 306, process 300 performs a static enzyme optimization. In one embodiment, process 300 performs a static enzyme optimization by performing a best of the worst process to optimize a set of processes. For example and in one embodiment, if a scientist submits an upstream and downstream enzyme without any “wildcard” nucleotides, a static enzyme optimization is appropriate. Static enzyme optimization is further described in FIG. 4 below.

If a wildcard enzyme optimization is selected, process 300 performs a wildcard enzyme optimization at block 308. In one embodiment, process 300 performs a wildcard enzyme optimization by computing prefix and suffix penalties for primers. For example and in one embodiment, an enzyme with an “N” as part of it will “match” any A, C, G, or T nucleotide. In one embodiment, wildcard enzymes increase the number of possible solutions and a special Wildcard Enzyme Optimization is used for this situation. Wildcard enzymes are enzymes that contain one or more of the International Union of Pure and Applied Chemistry (IUPAC) ambiguity codes. While the IUPAC codes for A, C, G, T, and U are for specific nucleotides, the codes M, R, W, S, Y, K, V, H, D, B, and N can refer to multiple nucleotides as known in the art. For example, the W code means A or T, the S code means G or C, and the N code means A, C, G, or T.

In one embodiment, a sequence with ambiguity codes can increase the number of possible primer-pair combinations to consider. For example and in one embodiment, the Sfi I enzyme contains 5 of the N ambiguity codes (GGCCNNNNNGGCC) resulting in 1024 possible combinations for this enzyme (each of the N codes could be an A, C, G, or T resulting in 4⁵ combinations). Referring to our A and B primer list example from the primer pair optimizer section, above, process 300 can have 102.5 million primer pair combinations as opposed to 100,000 primer-pair combinations.

In one embodiment, many of these combinations would result in poor individual primers and primer pairs. For example, any five nucleotide sequence is undesirable (AAAAA, GGGGG, etc.) as is any palindromic enzyme sequence (e.g., GAATTC).

In one embodiment, the wildcard enzyme optimizer eliminates many of these combinations by computing prefix and suffix penalties for primers. For example and in one embodiment, process 300 may eliminate restriction enzymes that fail melting temperature criteria, GC percentage, GC clamp, and/or other constraints. In this embodiment, it is possible for process 300 to pre-compute the melting temperature, GC percentage, and annealing penalties of these enzyme prefixes or suffixes to reduce computation time. The wildcard enzyme optimization performs both this pruning and pre-calculation to substantially reduce computation time.

If a multi-enzyme optimization is selected, process 300 performs a multi-enzyme optimization at block 310. In one embodiment, process 300 performs a multi-enzyme optimization by iterating over a list of inputted enzymes. For example and in one embodiment, a scientist may specify a list of enzymes to consider for either the upstream or downstream enzyme. In this case, process 300 solves for each of the possible enzymes (static or wildcard) and identifying the best results. In one embodiment, to reduce time, a simple baseline is created after the first solution to weed out poor results. In one embodiment, a primer and primer pair must be better than the “worst’ solution or it is not worth considering.

In one embodiment, the multi-enzyme optimization is the process of iterating the automated experiment design across a range of enzymes. For example, a scientist may not know which enzyme will produce the best results for an experiment and will request that the automated experiment design be run across all enzymes in his inventory. Similarly, a scientist conducting research in a specific area of DNA may want to learn the best possible restriction enzymes for a region and can request that some or all known enzymes should be considered as part of the automated experiment design. At block 312, process 300 returns the results.

FIG. 4 is a flow diagram of one embodiment of a process 400 to perform static enzyme optimization in order to rank six primer solutions. In one embodiment, process 400 is performed by process 300 at FIG. 3, block 304 above. Process 400 begins by receiving the static enzyme optimization input. In one embodiment, process 400 receives the list of primer regions, gene of interest (GOI), P1R start and end, P6 start and end, P2/P3 and P4/P5 enzymes, target sequence, construct sequence, primary criteria, primer heuristics, primer quality parameters, southern options, etc.). For example and in one embodiment, process 400 receives the input as illustrated in FIGS. 13-17 below.

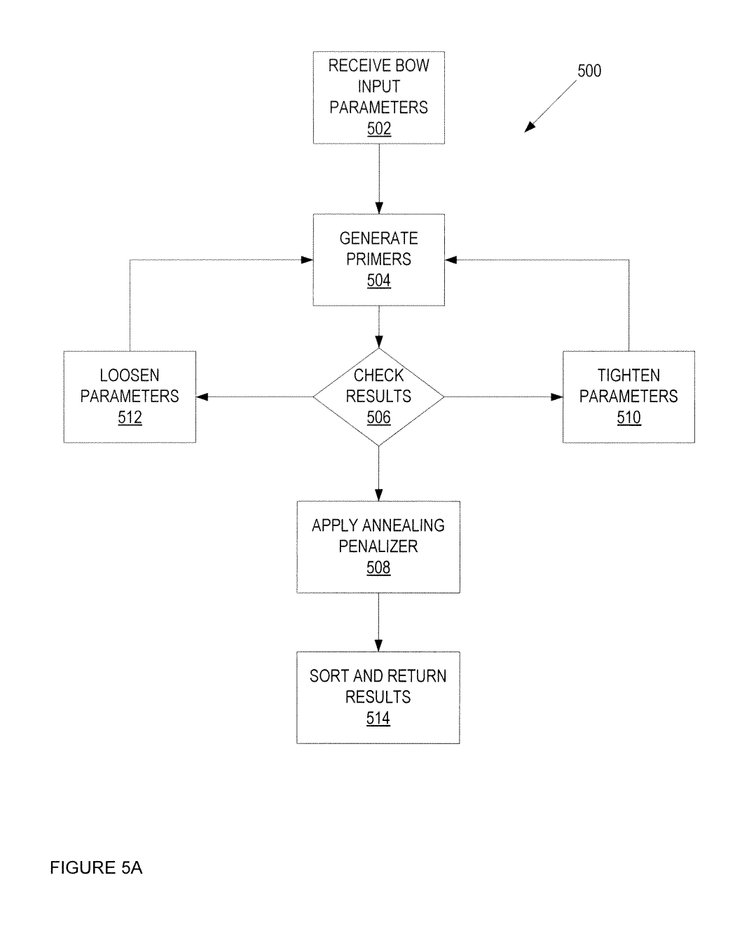

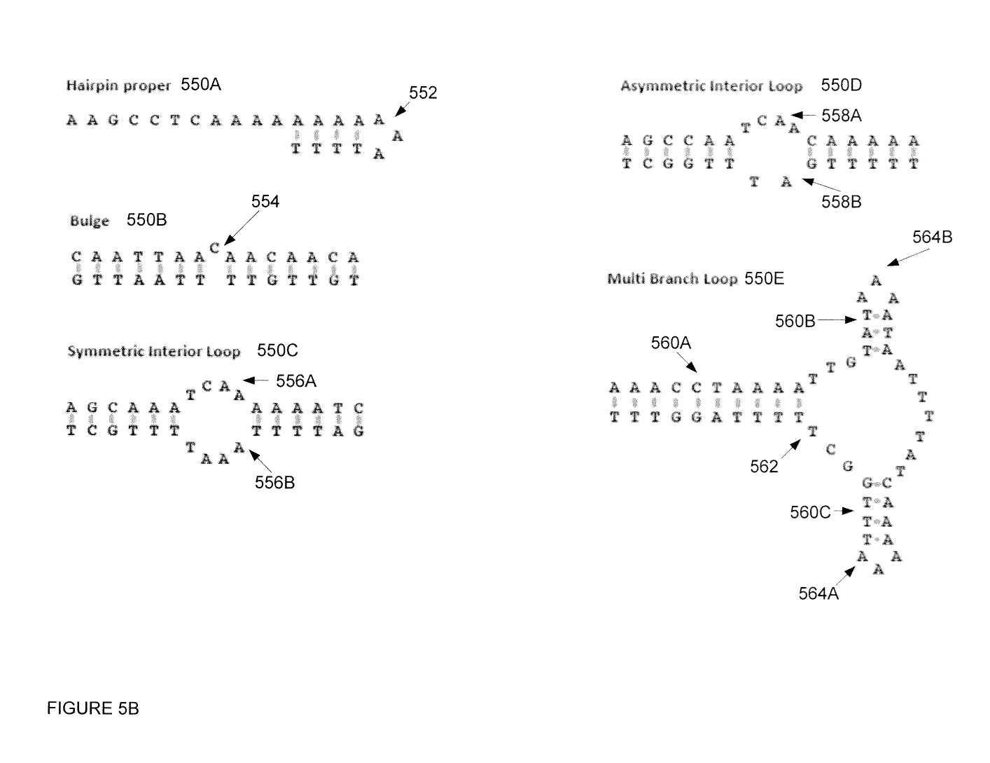

Process 400 generates a set of primers for each primer region 412A-F using a best of the worst process at blocks 404A-F, respectively. In one embodiment, a best of the worst process is an adaptive process for generating a minimum (and maximum) number of acceptable solutions for a primer range. For example and in one embodiment, each of these primers is given a scoring penalty and sorted before being returned as part of a primer list. The best of the worst process is further described in FIG. 5 below.

Process 400 optimizes pairs of primers at blocks 406A-C. In one embodiment, process 400 optimizes pairs of primers for P1/P2 pairs 414A at block 406A, P3/P4 pairs 414B at block 406B, and P5/P6 pairs 414C at block 406C. In one embodiment, each of these primer lists generated from the best of the worst processes 404A-F are joined into primer pairs (upstream pairs (P1/P2 pairs 414A), construct pairs (P3/P4 pairs 414B), and downstream pairs (P5/P6 pairs 414C)). Furthermore, a similar ranking and sorting process takes place for the primer pairs based on primer-pair annealing and temperature variance.

In one embodiment, primer pair optimization occurs by breadth-first search. Given two lists of primers, the primer pair optimizer produces a list of the optimal primer-pair combinations. A primer pair is considered optimal if each of the primers has a low annealing penalty (e.g., using the annealing penalizer described below in FIG. 5, block 508) and/or the melting temperature of the primers is within a desired threshold (e.g., three degrees).

For example and in one embodiment, suppose that process 400 generates a list of 100 primers for P1 at block 404A (list A) and another list of 1000 primers for P2 at block 404B (list 8). In this example, process 400 would process 100,000 different possible primer pairs. In one embodiment, process 400 returns a list of the 100 best primer-pairs out of a possible 100,000 primer-pair combinations. In one embodiment, the number of the primer-pair results to be returned in an input parameter received at block 402.

In one embodiment, process 400 reduces the amount of computation times for the primer pair optimization by performing a breadth-first search and using this information as a baseline. In one embodiment, a breadth-first search is a search that initially sets a bound and determines if primer pairs fall within the bound. For example and in one embodiment, suppose process 400 receives the A and B primer lists above, the scientists has requested the top 100 results, and each of the primer lists are both sorted by penalty (the best primers being first in the list). In this example, process 400 at block 406A begins by taking the first ten items from each of the primer lists (the square root of the desired number of results) and establishing a penalty baseline. In this embodiment, individual primers penalties that are better than the primer-pair penalty baseline are considered as a potential primer-pair.

In one embodiment, process 400 calculates a penalty for each primer based on different penalties. While in one embodiment, the penalties are based on primer design parameters input by the scientist (self-annealing, nucleotide repeats, deviation from ideal melting point temperature, deviation from ideal GC percentage, etc.), in alternate embodiments, other factor could be used to calculate penalties (ΔG dissimilarity penalty, etc.). For example and in one embodiment, the penalty for a primer is calculated based on Equation (1):

P=aₛₐpₛₐ+aᵣₑₚpᵣₑₚ+a_{Tm}p_{Tm}+a_{GC%}p_{GC%} (1)

where pₛₐ, pᵣₑₚ, p_{Tm}, and p_{GC%} are the calculated penalties for individual primer penalties for self-annealing, nucleotide repeat, deviation from ideal melting point temperature and deviation from ideal GC percentage and aₛₐ, aᵣₑₚ, a_{Tm}, and a_{GC}% are the respective weights. In one embodiment, process 400 calculates each of the individual penalties and use the inputted weights to determines the overall penalty for a primer with Equation (1).

For example and in one embodiment, if a primer in list A has a penalty that is worse than the 100^{th} primer pair combination, process 400 knows that the penalty of the combination pair is going to be worse than the 100^{th} item and process 400 can eliminate 1000 primer pair combination tests. In other words, if the penalty for A[i] primer is greater than the 100^{th} primer-pair penalty, process 400 can forgo computing the primer-pair penalties of {A[i ], B[1 . . . N]}.

In this example, process 400 has three lists of primer pairs that can be considered for an overall six-primer solution. If process 400 averages 1000 candidates for each floating primer and 20 candidates for each fixed primer, process 400 will have 20,000 potential primer pair candidates to process. At block 408, process 400 assembles combinations of six primers and ranks these combinations. In one embodiment, process 400 assembles the combinations of six primers by creating some or all possible combinations of six primer pairs from the P1/P2 414A, P3/P4 414B, and P5/P6 414C. In this embodiment, the three primer-pair lists of 20,000 candidates would yields eight trillion possible combinations. In practice, the majority of these combinations are could be poor choices. These poor combinations could be weeded out through the use of a “survivor” algorithm. In one embodiment, process 400 weeds out primer pairs by determining if a primer pair has a combined penalty that is greater than a threshold, other combinations of primer pairs using this one primer par are excluded, as these combinations will have a penalties that are above the threshold. For example and in one embodiment, if a P1/P2 primer pair has a penalty above a threshold, other combinations of P3/P4 primer pair with this P1/P2 primer pair would be weeded out from consideration by process 400 as the threshold of the P1/P2 primer pair and with other P3/P4 primer pairs would have a penalty greater than the threshold.

At block 410, process outputs the ranked list of six primer solutions. In one embodiment, process 400 returns the ranked list to the computations module that invoked process 400. In one embodiment, the ranked list is displayed in a user interface.

FIG. 5 is a flow diagram of one embodiment of a process 500 to use a best of the worst (BOW) algorithm to generate a number of acceptable solutions for the primer range. In one embodiment, the BOW is an adaptive algorithm for generating a minimum (and maximum) number of acceptable solutions for a primer range. For example and in one embodiment, some sequence ranges may fail to meet any of a scientist's criteria. In this embodiment, the BOW algorithm will “loosen” parameters to allow for a minimum number of possible solutions as opposed to simply returning zero results and failing. Similarly, the BOW algorithm will “tighten” parameters if there are too many results in a given sequence range. While loosening is useful for guaranteeing a minimum number of results, tightening is useful for saving time in the annealing penalizer and preventing combinatorial explosion in the primer pair analyzer.

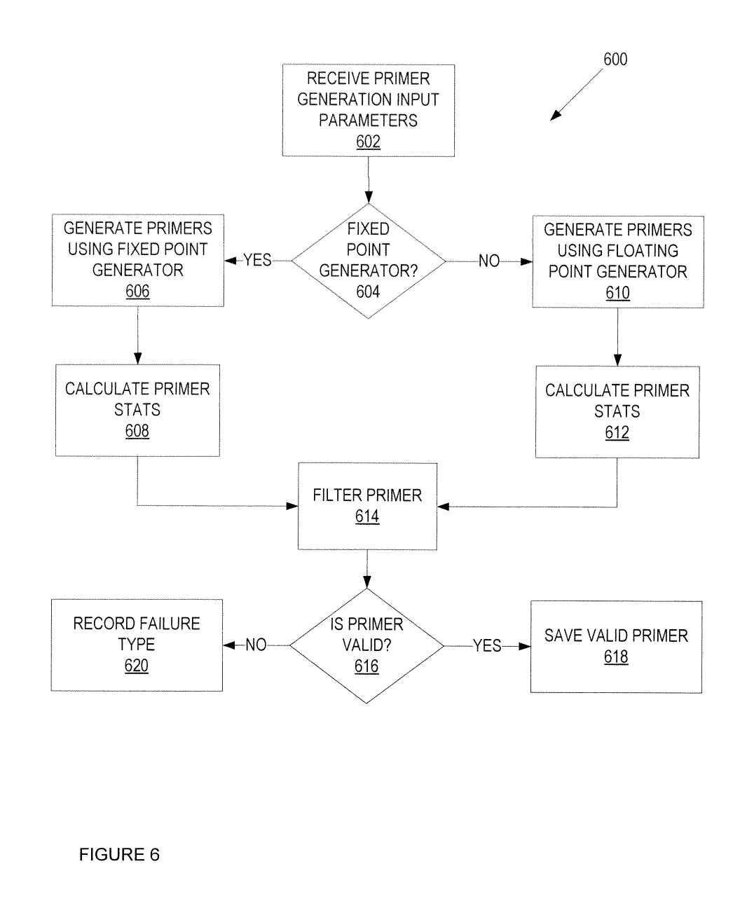

Process 500 begins by receiving the BOW input parameters. In one embodiment, process 500 receives inputs for input primer range, melting temperature range, GC Range, and GC Clamp, etc. At block 504, process 500 generates the primers for the input range and other parameters. In one embodiment, process 500 generates the primers by grabbing sequences from the DNA template within the length and position restraints and adds all possible additions (such as the enzyme sequence). Generating the primers is further described in FIG. 6 below.

At block 506, process 500 checks the results of the primer generation. If there are too many generated primers, process 500 tightens the parameters at block 510. Execution proceeds to block 504 above with the tightened parameters. If there are too few generated primers at block 506, process 500 loosens the parameters at block 512. Execution proceeds to block 504 above with the loosened parameters.

In one embodiment, loosening and tightening of the input parameters are accomplished by increasing or decreasing various parameter ranges. For example and in one embodiment, process 500 can loosen or tighten melting temperature range, GC Range, GC Clamp, AG dissimilarity parameter, etc. to allow a minimum number of results or limit an exceptional number of valid primer results. For example and in one embodiment, process 500 starts with the parameters as specified by a scientist. If a satisfactory number of results are not obtained process 500 adjusts parameters accordingly. In one embodiment, process 500 initially adjusts the GC range, by expanding or loosening the range by 1% for each loosening/tightening round. For example and in one embodiment, process 500 can adjust the parameters for 6 rounds (the number is adjustable) before resetting back to normal and attempting to adjust the temperature range.

In another embodiment, process 500 can similarly adjusts the temperature range by 1 degree Celsius for six rounds. The adjustment value and number of rounds are also adjustable. Primer length, GC clamp, and other options can be adjusted in similar ways until a desired number of results is achieved.

Once a desired number of results has been achieved, at block 508, process 500 calculates annealing penalties for each primer through the Annealing Penalizer. These primer results are sorted by penalty and returned at block 514. In one embodiment, an annealing penalty is a measure of the desirability of an individual primer. In one embodiment, an annealing penalty is calculated by comparing the melting temperature or ΔG of a primer's secondary structure to the melting temperature or ΔG of the desired primer-to-template binding. The smaller the difference between these two values, the larger the penalty. Conversely, the larger the difference between these two values, the smaller the penalty.

In one embodiment, the annealing penalizer is a process that simulates the annealing of a primer to itself or to another primer. Annealing is the strength at which a sequence of nucleotides binds to another sequence of nucleotides. The higher the annealing between two primers, the less desirable these primers are for an experiment.

In one embodiment, the input to the annealing penalizer is the template DNA and primer and the annealing penalizer outputs a percentage of wanted binding/ratio of wanted to unwanted binding. In one embodiment, a primer binds to the template at the desired location with a given ΔG. Process 500 determines the AG using one of the ways as known in the art (e.g., nearest neighbor thermodynamics, predicted secondary structure, etc.).

In one embodiment, process 500 uses a heuristic to determine where along the template DNA significant parts of the primer might bind. In this embodiment, both the sense and anti-sense strands are checked. In another embodiment, one of the sense and anti-sense strands area checked. For example and in one embodiment, process 500 checks the template using a BLAST, Smith-Waterman, secondary structure prediction, or other known algorithm known in the art for determining binding affinity. In another embodiment, other algorithms as known in the art are used to determine binding affinity. In one embodiment, process 500 saves primer areas that have a similarity amount above a threshold.

For the primer areas that have a close enough similarity, along with flanking nucleotides on the template to ensure the segment is longer than the primer, process 500 checks these primer areas against the primer for pair binding (heterodimer), and a ΔG is calculated based on these methods. For example and in one embodiment, process 500 uses an algorithm as known in the art to determine ΔG for pair binding (e.g., secondary prediction algorithm that is based on nearest neighbor thermodynamics). If the pair ends up with a positive or 0 ΔG, it is discarded. If the ΔG is negative, process 500 records the ΔG and saves this primer for later.

Given a set of primer to template segment bindings and their associated ΔGs, process 500 determines the percentage of wanted binding and unwanted binding at the annealing temperature. in one embodiment, process 500 does this by assuming the thermodynamic product of reaction from single strands to double strands at a given temperature. This gives a ratio of wanted to unwanted binding as well. In addition, process 500 can give an overall secondary binding score to each primer, which is already normalized. Process 500 further compares the different primers based on this secondary binding score, and process 500 can weigh the importance of this parameter relative to the other primer parameters however the experimenter wishes (this is done later, outside of the secondary binding determination).

In one embodiment, process 500 includes the ability to distinguish whether a single strong secondary binding is solely responsible for removing X % of wanted binding or whether it is many unwanted weak secondary bindings. In this embodiment, this can lead to a better secondary binding score, because strong unwanted binding can be worse than many weak unwanted bindings. In another embodiment, process 500 determines if the unwanted bindings are close to a reverse primer (wanted or unwanted), thus creating small amplicons (amplified/copied regions of DNA during PCR) that will compete heavily with the desired region of amplification during the exponential copying stages of PCR. In a further embodiment, process 500 determines the sizes of any unwanted amplicons to see if these amplicons differ enough from the desired region to be separated during gel electrophoresis (this would only be desired if the scientist absolutely could not use any other primers and was stuck with some really bad secondary binding).

For example and in one embodiment, the types of intra-primer, inter-primer, and primer-template interactions that can occur are:
1. Hairpins—how a single-stranded sequence (e.g., a primer) binds to itself.
2. Homodimers—how two, single-strands, of the same sequence (e.g., a primer) bind to each other.
3. Heterodimers—how two, single-strands, of different sequences (e.g., different primers) bind to each other
4. Desired Binding—how a single-stranded primer (including a primer that is attached to an enzyme) binds to the template.
5. Secondary Binding—how a single-stranded primer (including a primer that is attached to an enzyme) binds to outside of the template.

In one embodiment, the experimental design aims to develop sets of primers and primers-enzymes that reduce the negative impact of hairpins, homodimers, heterodimers, and secondary binding. In this embodiment, by reducing the negative impact of the above secondary structures, the desired binding is increased, which is a scientist's goal.

Many annealing penalizers models known in the art are based on the ΔG of the folded sequence. While in one embodiment, secondary structure prediction is a technique known in the art for determining a sequence's ΔG, in alternate embodiments different techniques can be used (tertiary structure prediction, heuristics, etc.).

Some example techniques that can be employed are:

Heuristic-based models: These techniques tend to rely on rules of thumb, instead of numerically calculating a ΔG. For example and in one embodiment, a process can penalize sequence(s) that are above or below a specific GC % range, melting temperature range, looking for a GC clamp at the end of a sequence, not allowing more than N-binds in a row when using a sliding window approach, etc.

Other heuristic models can use temperature heuristics. Some of the most basic temperature penalizing examples are the Wallace rule (T_{d}=2° C.(A+T)+4° C.(G+C)) and the Howley formula (Tm=81.5+16.6 log M+41(XG+XC)−500/L−0.62F). Melting temperatures that are close to the desired binding melting temperature are penalized more than those that are far away from the desired binding melting temperature.

Another technique is base pair maximization. In this technique, the base pair binding of the desired binding is compared to the base pair binding of the undesired bindings and penalized in a similar fashion to temperature.

In alternative embodiment, a combination of heuristic models can be used. For example and in one embodiment, a combination of a temperature penalty, a GC penalty, an individual bind-penalty, and a penalty for stems that were longer than a fixed length can be employed.

Minimum Free Energy Models: A minimum free energy model is another technique known in the art. In these techniques, the closer the ΔG to the desired binding ΔG, the higher the penalty. An alternative minimum free energy model is to use an equilibrium partition function to predict the structure with the minimum free energy. There are several variations of this approach as known in the art. A further approach is to use minimum free energy model and existing sequence alignments (homology-based-prediction) to aid in a minimum free energy determination.

Maximum Expected Accuracy (MEA): MEA-based approaches are driven by statistical learning on a given data set as opposed to thermodynamic or probabilistic models. Some various approaches with references follow. These techniques are used to describe the secondary structure and the ΔG of this structure is computed and used as a penalty. Other MEA-based approaches that could be employed are: Stochastic Context-Free Grammar (SCFGs), Conditional Log-Linear Models (CLLMs).

Machine Learning Models: As known in the art, machine learning approaches rely on data set training that can give accurate results, which depend on the training set to train the model. Two techniques that have been used in secondary structure prediction are support vector machines and neural networks: Support Vector Machines and Neural Networks.

FIG. 5B is an illustration of different types of secondary structure 550A-E. In FIG. 5B, five different types of secondary structure are illustrated: hairpin proper 550A, bulge 550B, symmetric interior loop 550C, asymmetric interior loop 550D, and multi-branch loop 550E. In one embodiment, a hairpin proper 550A occurs when a primer folds onto itself leaving a bulge 552 in the primer. For example and in one embodiment, the primer illustrated in the hairpin proper 550A has a bulge sequence 552 of AAA that is caused by the primer sequences of the TTTT folding over and binding to the AAAA primer sequence. While the embodiment illustrated in 550A has a hairpin bulge 552 of three nucleotides, in alternate embodiments, the hairpin bulge 552 can include greater or lesser numbers of nucleotides.

Another type of secondary structure is the bulge 550B. In one embodiment, the bulge 550B results from one or more nucleotides in a primer not binding to a nucleotide in the other primer. For example and in one embodiment, in bulge 550B, each nucleotide in the top primer sequence binds to a corresponding nucleotide in the bottom primer sequence, except for the C nucleotide that constitutes the bulge 554. In this embodiment, this bulge 554 results because the cytosine (C) nucleotide does not bind to the thymine (T) nucleotides that are opposite from the C nucleotide in the bulge 554. While in this embodiment, the bulge 554 include one nucleotide, in alternate embodiments, the bulge 554 can be more than one nucleotide and/or include the same or different types of nucleotides.

The next two secondary structures are interior loops formed by a single primer sequence or multiple primer sequences binding to each other, which are the symmetric interior loop 550C and the asymmetric interior loop 550D. The symmetric interior loop 550C is formed from two primer sequences, where a loop of equal number of nucleotides in each primer sequence do not bind to each other. In one embodiment, the symmetric interior loop 550C includes a loop 556A-B, where each of the top 556A and bottom 556B segments of the loop each includes four nucleotides. In this embodiment, this loop results from the nucleotides in the top segment 556A and the nucleotides in the bottom segment 556B not binding to each other. For example and in one embodiment, the TCAA segment 556A does not bind to the TAAA 556B segment because T does not bind to another T, C does not bind to A, A does not bind to itself A. While in one embodiment, the top and bottom segments 556A-B of the loop include four nucleotides, in alternate embodiments, the top and bottom segments can have greater or lesser number of nucleotides and/or include the same or different types of nucleotides.

The asymmetric interior loop 550D is similar to the symmetric interior loop 550C except that the top and bottom segments 558A-B of the loop each have different numbers of the nucleotides. For example and in one embodiment, the TCAA segment 558A does not bind to the TA 558B segment because T does not bind to another T or A, C does not bind to T or A, A does not bind to itself (A). While in one embodiment, the top and bottom segments 558A-B of the loop include four nucleotides, in alternate embodiments, the top and bottom segments can have greater or lesser number of nucleotides and/or include the same or different types of nucleotides.

The multi-branch loop 550E is a primer sequence where there are multiple branches 560A-C that branch off a loop 562 of nucleotides. In one embodiment, the multi-branch loop 550E can be a single primer sequence or two or more primer sequences. As with the loops 550C-D described above, the loop 562 results from nucleotides that do not bind to a neighboring nucleotide. For example and in one embodiment, the loop 562 includes segments TTG, ATTTTAT, and GCT that do not bind to a neighboring nucleotide.

In addition, the multi-branch loop 550E, includes the primer sequences that bind to each other form the branches 560A-C. For example and in one embodiment, branch 560A includes ten base pairs, branch 560B three base pairs, branch 560C includes four base pairs. Furthermore, multi-branch loop 550E can include bulges 564A-B where the primer sequence folds back onto itself. For example and in one embodiment, branch 564A include an AAA bulge 564A that allows the formation of branch 560C. In addition, in this embodiment, branch 560B include another AAA bulge 564B that allows the formation of branch 560B. While in one embodiment, the multi-branch loop 550E include three branches 560A-C, a loop 562, and two bulges 564A-B, in alternate embodiments, the multi-branch loop 550E can includes a greater or lesser number of branches, loops, and/or bulges.

FIG. 6 is a flow diagram of one embodiment of a process 600 to generate a primer. The primer generator is designed to generate fixed (e.g., including degenerate) or floating primers, calculate primer statistics for each of these primers, and send this information to a filter for analysis. The primer statistics primarily contain the primer's melting temperature and GC count, although other items can be computed for future analysis. Process 600 begins by receiving primer generation input parameters at block 602. In one embodiment, the primer generation input parameters are primer range, primer length, CG content range, and melting temperature range.

At block 604, process 600 determines if the fixed point generator is requested. In one embodiment, an input parameter specifies whether the primer generator is working on a fixed or floating primer range. If working on a fixed primer range, process 600 generates primers at block 606 with a fixed point generator. In one embodiment, process 600 appends the sequence range to the enzyme and “walks” this range. Process 600 generates primer statistics for the generated primer at block 608. Execution proceeds to block 614.

If the floating point generator was requested, process 600 generates primer using the floating point generator. In one embodiment, process 600 walks the supplied floating primer range. In this embodiment, walking a primer consists of generating statistics and passing these statistics to the primer filter at block 612. In one embodiment, the statistics are generated by “walking” a minimum and maximum length primer across an entire sequence range. For example and in one embodiment, the CG content is computed by adding the number of Cs and Gs in the primer segment and dividing this number by the total number of nucleotides (As, Cs, Ts, and Gs). The computed number is converted into a percentage by multiplying by 100.

In another example and another embodiment, process 600 computes a melting temperature using one or more ways to calculate a melting temperature as known in the art. As is known in the art, there are many variations on how to calculate melting temperature. These variations differ due to updated data sets from empirical determination of parameters, or from describing a different approach to the problem. For example and in one embodiment, process 600 calculates a melting temperature of a primer using a Nearest Neighbor Thermodynamics approach that uses the thermodynamic tables. In this embodiment, the basic equation (2) for determining melting temperature in Celsius is:

dH*1000/(dS+R*ln(Ct/x))−273.15+[salt correction] (2)

where dH is the sum of nearest neighbor enthalpy parameters, dS is the sum of nearest neighbor entropy parameters, R is the molar gas constant, Ct is the molar concentration of DNA, and x is a parameter whose value depends on the palindromic quality of the primer. There are also corrections for salt concentrations in the mixtures.

For example and in one embodiment, if process 600 is to walk a sequence of 1000 nucleotides across a primer length range of 25-35 nucleotides, process 600 will start at the first nucleotide, take the first 25 nucleotides, compute primer statistics, and pass this information to the primer filter. Process 600 increases the primer length by 1 and repeats this process. Once process 600 has reached the maximum length primer, process 600 will advance the primer start to the second nucleotide and repeat this minimum/maximum primer length process. In this embodiment, process 600 will continue to advance the start of the primer until it reaches the smallest possible primer at the end of the floating primer range. In this case, since the minimum primer length is 25, the last primer start would be at the 975^{th} nucleotide in the range and the last primer end would be at the 1000th nucleotide. Process 600 thus walks a primer length range across a sequence.

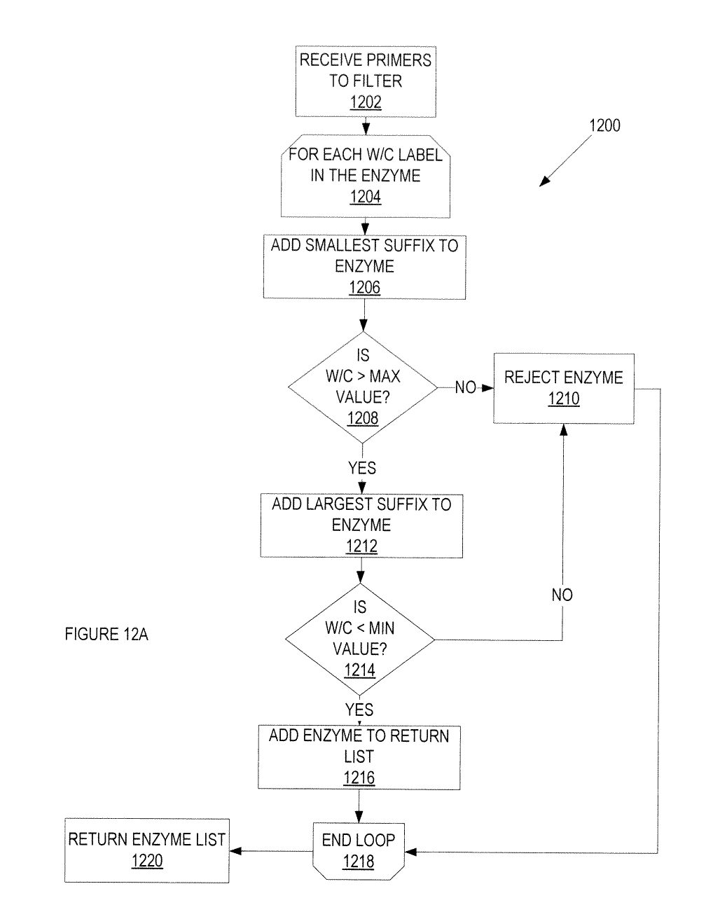

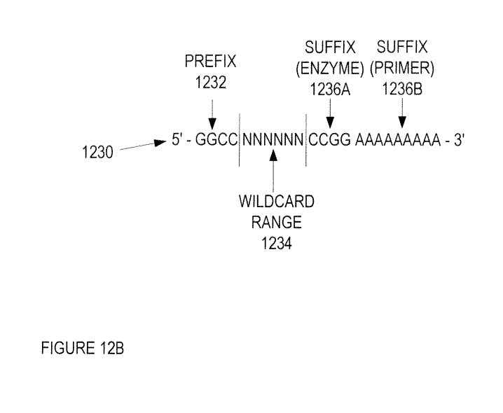

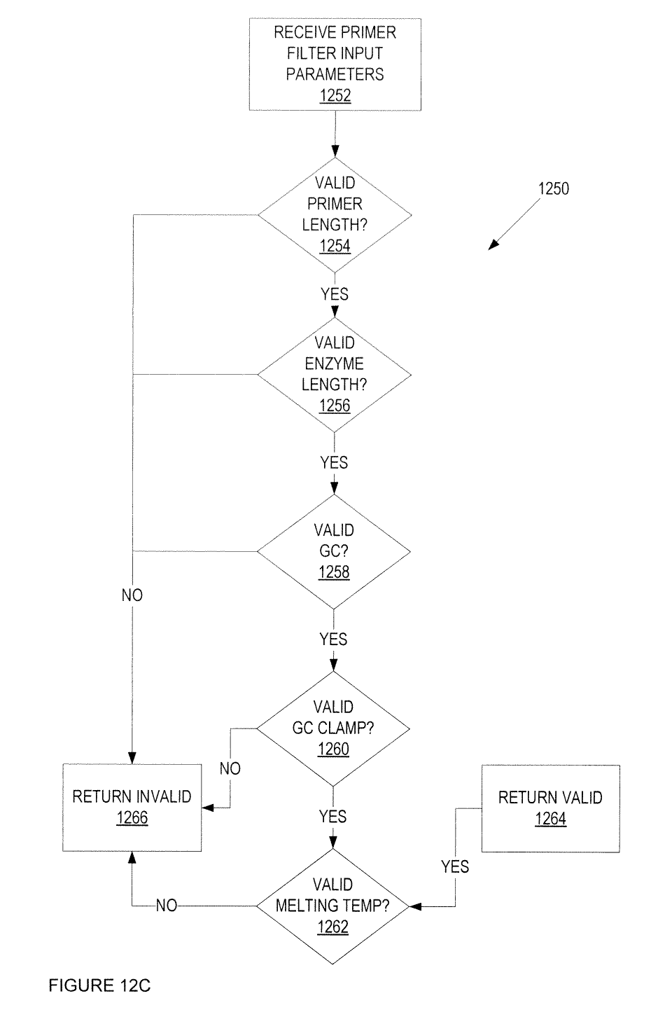

At block 614, process 600 filters the generated primer. In one embodiment, process 600 decides to accept or reject the primer based on the primer statistics generated by the primer generator and the primer options specified by a scientist. Primer filtering is further described in FIG. 12C below. Process 600 determines if the generated primer is valid at block 616. If the primer is valid, process 600 saves the valid primer at block 618. If the primer is not valid, process 600 records a failure type at block 620.

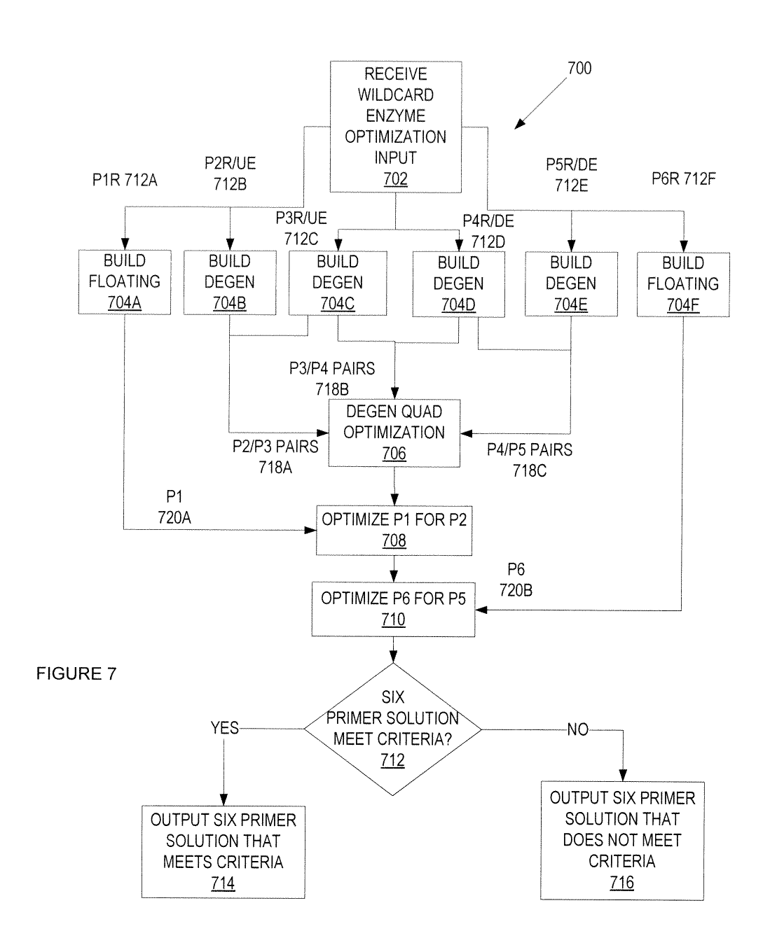

FIG. 7 is a flow diagram of one embodiment of a process 700 to perform wildcard enzyme optimization in order to rank six primer solutions. In one embodiment, process 700 is performed by process 300 at block 308 in FIG. 3 above. As described above, process 700 performs a wildcard enzyme optimization by computing prefix and suffix penalties for primers. In one embodiment, a wildcard enzyme in an enzyme that includes one or more of the IUPAC ambiguity codes (e.g., codes M, R, W, S, Y, K, V, H, D, B, N, etc.). For example and in one embodiment, the Sfi I enzyme contains 5 of the N ambiguity codes (GGCCNNNNNGGCC) resulting in 1024 possible combinations for this enzyme.

At block 702, process 700 receives the wildcard enzyme optimization input. In one embodiment, process 700 receives the list of primer regions, gene of interest (GOI), P1R start and end, P6 start and end, P2/P3 and P4/P5 enzymes (where one or more of the enzymes include wildcard codes), target sequence, construct sequence, primary criteria, primer heuristics, primer quality parameters, southern options, etc.). For example and in one embodiment, process 700 receives the wildcard enzyme such as the Sfi I enzyme that includes ambiguity codes for one of the input primer criteria along with the other primer inputs.

Process 700 computes the different primers for primers P1-P6 at blocks 704A-F. At blocks 704A, F, process 700 build floating primers. In one embodiment, a floating primer is a primer that is not tied down to a particular location in the DNA of interest 120. For example and in one embodiment, primers P1 and P6 are floating primers, such as primers P1 132A and P2 132F as illustrated in FIG. 1B above. In one embodiment, process 700 builds the floating primers using the best of the worst algorithm as described in FIG. 5 below.

At blocks 704B-E, process 700 computes primer candidates for the degenerate primers. In one embodiment, the degenerate primers are the primers that are either attached or close in proximity to the target or insert as described above with reference to FIG. 1B above. For example and in one embodiment, the degenerate primers are P2-P5 132B-E as illustrated in FIG. 1B above. In this embodiment, the P2 primer 132B is part of the anti-sense strand 126B and primer P5 132E is part of the sense strand 126A. Furthermore, the P2 132B and P5 132E primers are outside of the range of the target 130 but in close proximity to the target 130. In addition, the primer P3 132C is part of the insert 136A and on the sense strand 126A, while the primer P4 132D is opposite the insert 136A and on the anti-sense strand 126B.

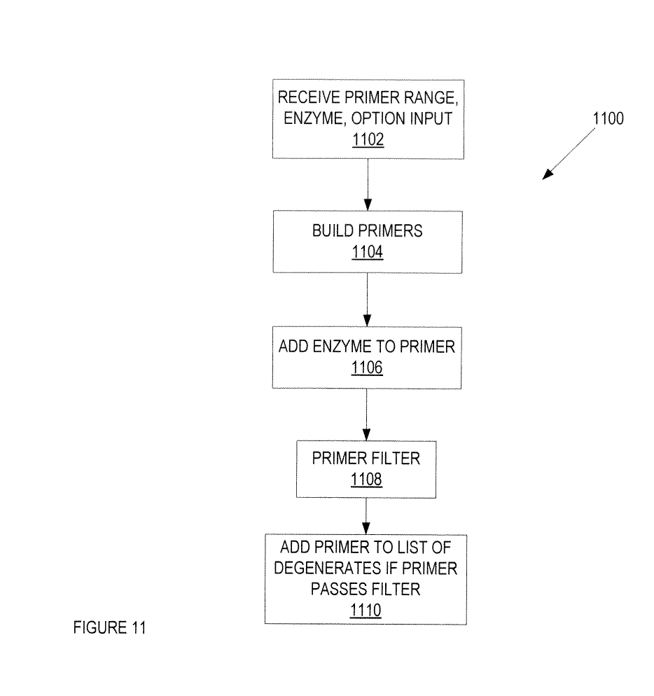

In one embodiment, process 700 computes the primer candidates P2-P5 with a wildcard enzyme by eliminating invalid wildcard prefixes and suffixes as described further in FIG. 11 below.

At block 706, process 700 receives the primer candidates for P2-P5 (714A-C) and performs a degenerate quad optimization. In one embodiment, process 700 performs the degenerate optimization to generate one or more P2-P3-P4-P5 solutions. In this embodiment, because the degenerate primers P2-P5 are fixed, there relatively few possible solutions for each of the degenerate primers, because the primer ranges on the sense or anti-sense strand are relatively fixed. In one embodiment, one end of the degenerate primers P2-P5 is fixed at the boundary of either the target or insert. For example and in one embodiment, and with Reference to FIG. 1B above, the downstream end of the P2 primer 132B is attached to the target 130 and upstream end of the P5 primer 132E is attached to the target 130. Furthermore, the upstream end of the P3 primer 132C is at the upstream end of the sense strand 126A of the target 130 and the downstream end of the P3 primer 132C is at the downstream end of the insert 136A on the sense strand 126A and the downstream end of the P4 primer 132D is on the anti-sense strand 126B and opposite the downstream end of the insert 136A. In another embodiments, the primers P2-P5 are not aligned with either upstream or downstream boundaries of the target or insert, but are within a number of nucleotide positions of the target or insert boundary (e.g. 1-20 positions from the target or insert boundary).

In one embodiment, process 700 determines the degenerate quad solution using a dynamic programming techniques to optimize pairs of the degenerate primers and successively build larger sets of primers. In one embodiment, dynamic programming is a method of solving complex problems by breaking them down into simpler subproblems and combing the results of these subproblems into an overall solution. Dynamic programing makes it possible to solve exponentially complex problems in a realistic amount of time.

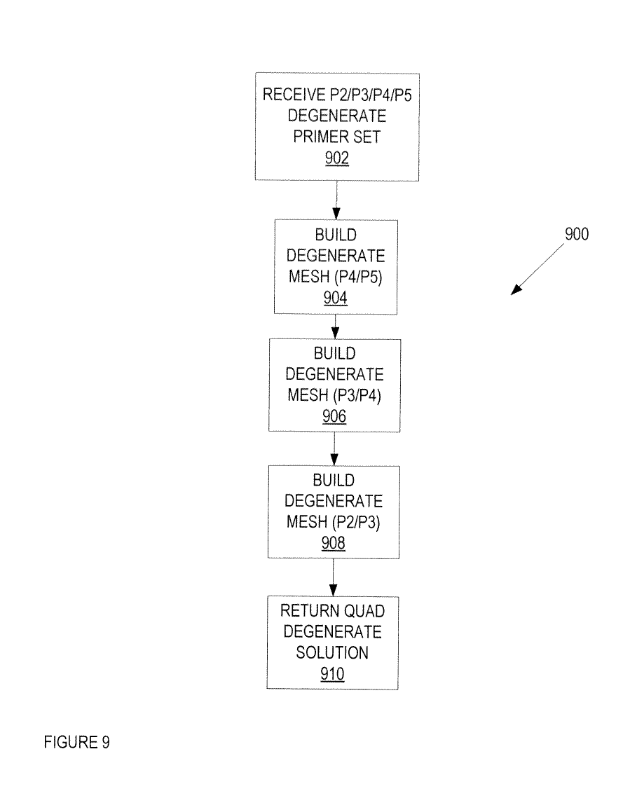

In one embodiment, process 700 optimizes a P4/P5 pair of primers. Using these optimized P4/P5 primer pairs, process 700 optimizes a set of P3/P4/P5 solutions using results of the P4/P5 optimization. In this embodiment, by using the optimized sets of P4/P5 primers, process 700 has reduced the number of computations needed to arrive at the P3/P4/P5 solutions. Furthermore, process 700 uses the results of the P3/P4/P5 optimization to optimize a set of P2/P3/P4/P5 solutions. Similar to the P3/P4/P5 optimization, by using the optimized P3/P4/P5 set of solutions, process 700 reduces the number of computations to optimize the set of P2/P3/P4/P5 solutions. In this embodiment, the set of P2/P3/P4/P5 solutions is the degenerate quad solution. Optimizing the degenerate quad solution is further described in FIG. 9 below.

In the embodiment, described above, the degenerate quad solution was computed by solutions in the order P4/P5 ->P3/P4/P5 ->P2/P3/P4/P5. In other embodiments, the order in arriving at the quad degenerate solutions can be different. In another embodiment, process 700 starts the optimization process by optimizing the P2/P3 set of solutions and using this set of solutions to optimize a P2/P3/P4 set of solutions, and using the P2/P3/P4 set of solutions to optimize a P2/P3/P4/P5 set of solutions. In an alternate embodiment, process 700 initially optimizes a P3/P4 set of solutions and uses this optimized set of solutions to optimize either a P2/P3/P4 or P3/P4/P5 sets of solutions. In this embodiment, process 700 can use either P2/P3/P4 or P3/P4/P5 sets of solutions to optimize the degenerate quad set of solutions, P2/P3/P4/P5.

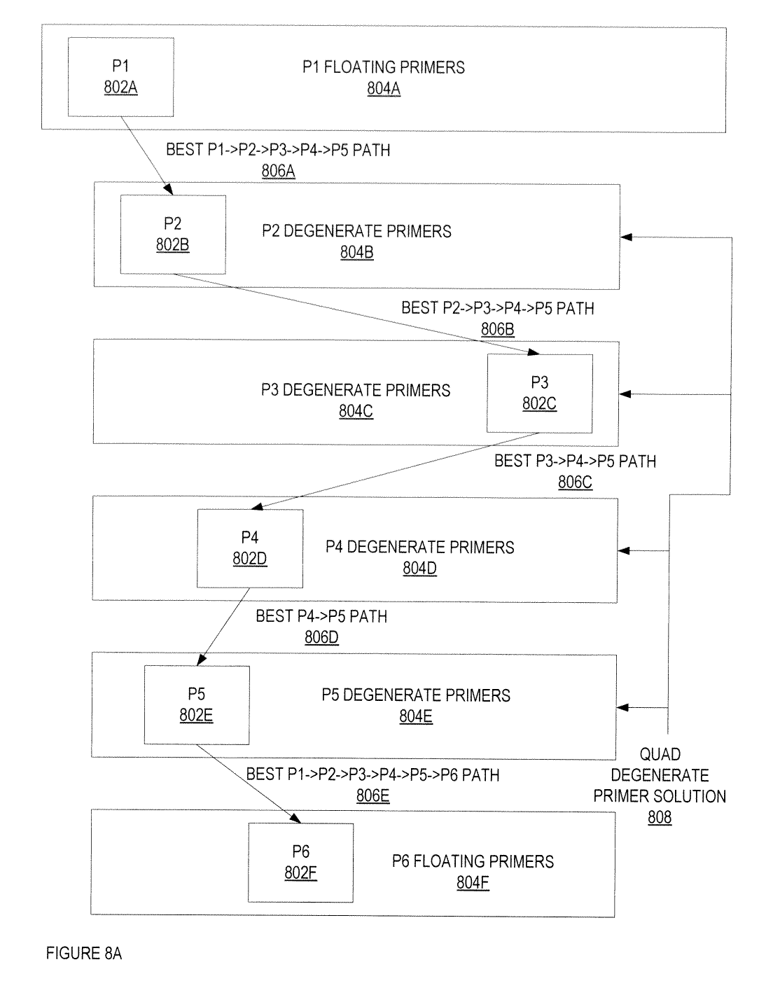

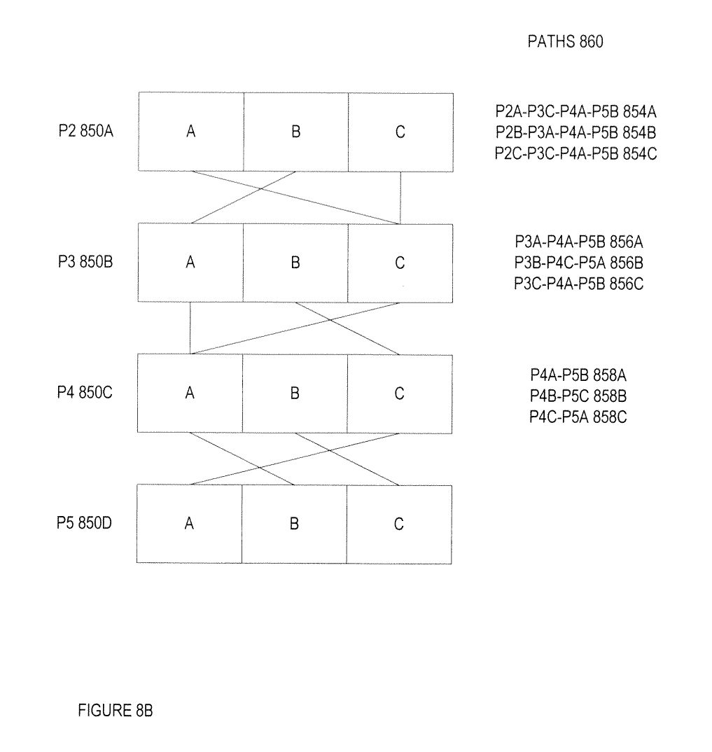

FIG. 8 is a block diagram of one embodiment of a dynamic programming approach 800 for solving a six primer degenerate primer mesh. In FIG. 8, the approach 800 illustrates, in one embodiment, using dynamic programming to calculate a six primer solution set(s). As described above, dynamic programming is a method of solving complex problems by breaking them down into simpler subproblems and combing the results of these subproblems into an overall solution. Dynamic programing makes it possible to solve exponentially complex problems in a realistic amount of time. In one embodiment, this approach 800 breaks down the larger problem of calculating a six primer solutions from thousands or millions of possibilities into smaller subproblems of calculating a pair of degenerate primers and adding another optimal primer to the degenerate pair. This approach 800 finds another degenerate primer to arrive at a quad primer solution set and adds the floating primers (P1 & P6) to arrive at the six primer solution set(s).

In one embodiment, the possible primers that can be used to calculate are primer sets 804A-F (P1 floating primers 804A, P2 degenerate primers 804B, P3 degenerate primers 804C, P4 degenerate primers 804D, P5 degenerate primers 804E, and P6 floating primers 804F). In one embodiment, because the floating primers can be calculated from a large range on the sense (P1) or anti-sense strand (P6), there can be a relatively large number of possible floating primers. On the other hand because, in one embodiment, one of end of the degenerate primers is relatively fixed, the possible number of degenerate primers for each of P2-P5 is relatively small.

In one embodiment, the approach 800 computes a quad degenerate solution set 808. In this embodiment, the approach 800 is to calculate one or more paths from P2->P3->P4->P5 to arrive at the quad degenerate primer solution set. Using this quad primer solution set 808, the approach calculates paths from P5->P6 and P1->P2 to arrive at a six primer solution set(s).

For example and in one embodiment, the approach 800 calculates different paths 806A-E using primers 802A-F. The approach 800 calculates an optimal P4->P5 path 806D using primers P4 802D and P5 802E and uses this path to calculate an optimal P3->P4->P5 path 806C with primer P3 802C. The approach uses path 806C and primer 802D to calculate the quad degenerate primer solution 808, which is path P2->P3->P4->P5 806B. Using the quad degenerate primer solution 808, the approach 800 calculates the paths that include the optimal floating primers P1 802A for path P1->P2->P3->P4->P5 806A and P6 802F for path P1->P2->P3->P4->P5->P6 806F. This dynamic programming approach is further described in FIGS. 7 and 9-12A.

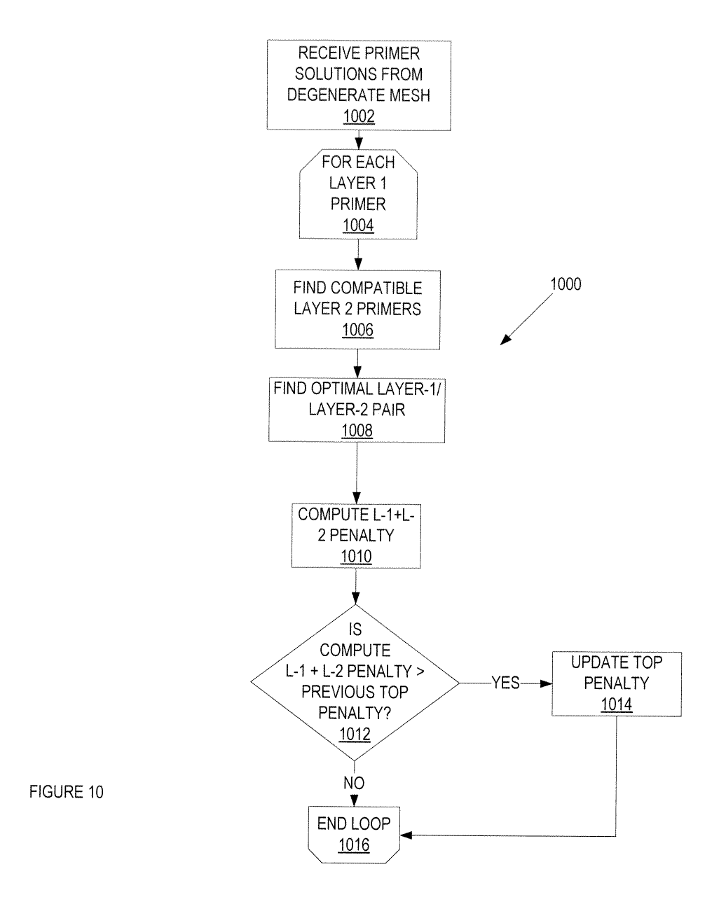

FIG. 8B is a block diagram of one embodiment of a dynamic programming approach 800 that builds a series of degenerate primer meshes for primers P2-P5 860. In FIG. 8B, a series of primer paths is illustrated that are built up using the approach 800. In one embodiment, approach 800 builds a series of degenerate meshes 854A-C, 856A-C, and 858A-C. In this embodiment, each degenerate mesh includes a set of paths between sets of primer candidates 850A-D. In FIG. 8B, primers P2-P5 850A-850D each have three primer candidates in the primer solution set (primers A-C). In this embodiment, the approach 800 creates paths between the primer candidates for each primer solution set, depending on the layers that are input. For example and in one embodiment, in creating the P4/P5 degenerate mesh, the input layers are the primer candidates for P4 850C and P5 850D. In this embodiment, the approach 800 determines optimal paths between primers in the P4 primer candidate set 850C and P5 primer candidate set 850D. For example, approach 800 determines that the optimal primer for P4A is PSB, so one of the paths is P4A-P5B 858A. In one embodiment, the approach 800 determines the optimal primers using the process as described in FIG. 10 below.

In addition, approach 800 determines that the optimal primers for primer P4B is PSC and the optimal primer for P4C is PSA. In this embodiment, the approach determines a set of paths 858A-C between the primers in the P4 primer candidate set 850C and the P5 primer candidate set P5 850D. This set of paths is P4A-P5B 858A, P4B-P5C 858B, and P4C-P5A 858C. While in this embodiment, the approach has determined a set of three paths between primer candidate sets that each have three primer candidates, in alternate embodiments, the number of paths that are determined and the number of primers in each or both primer candidate sets can be the same, greater or smaller. In one embodiment, the determining of paths between two sets of primer candidate sets for P4 and P5 creates the P4/P5 degenerate mesh as described in FIG. 9, block 904 below.

Furthermore, this approach 800 builds a larger degenerate mesh from a smaller degenerate mesh by determining new primer paths between a primer candidate set and an input degenerate mesh. In one embodiment, approach 800 determines a path between one of the primers in the primer candidate set and one of the primer paths in the input degenerate mesh. For example and in one embodiment, approach 800 determines paths between the P3 primer candidate set 850B and the paths 858A-C of the P4/P5 degenerate mesh. In this embodiment, the approach determines that the optimal primer for P3A is P4A, resulting in the primer path P3A-P4A-P5B 856A. Similarly, approach determines the paths P3B-P4C-P5A 856B and P3C-P4A-P5A 856C. In addition, the paths 856A-C determined by approach 800 is the P3/P4 degenerate mesh as described in FIG. 9, block 906 below.

In addition, the approach 800 determines the four primer paths 854A-D for the P2/P3 degenerate mesh. In one embodiment, the P2/P3 degenerate mesh includes paths P2A-P3C-P4A-P5B 854A, P2B-P3A-P4A-P5B 854B, and P2C-P3C-P4A-P5B 854B 854C. In one embodiment, this set of four primer paths is the quad degenerate solution that is computed in FIG. 9, bock 908 and FIG. 7, block 706.

Returning to FIG. 7, at block 708, process 700 optimizes the P1 primer for P2 using the degenerate quad solution as optimized in block 706. In one embodiment, process 700 optimizes a primer pair using a breadth-first search process as described above in FIG. 4, block 414A above. In this embodiment, process 700 the primer pair optimizer produces a list of the optimal primer-pair combinations. A primer pair is considered optimal if each of the primers has a low annealing penalty (e.g., using the annealing penalizer described below in FIG. 5, block 508) and the melting temperature of the primers is within a desired threshold (e.g., three degrees).

At block 710, process 700 optimizes the P6 primer for P5 primer using the degenerate quad solution as optimized in block 706. In one embodiment, process 700 optimizes a primer pair using a breadth-first search process as described above in FIG. 4, block 414C above. In this embodiment, process 700 optimizes the primer pair by producing a list of the optimal primer-pair combinations. A primer pair is considered optimal if each of the primers has a low annealing penalty (e.g., using the annealing penalizer described below in FIG. 5, block 508) and the melting temperature of the primers is within a desired threshold (e.g., three degrees). In one embodiment, at block 710, process 700 has produced the one or more six primers solution for use in block 712 below.

At block 712, process 700 determines if each or the one or more six primer solutions produced at block 710 above meets the criteria input by the scientist. In one embodiment, the input criteria is melting temperature, GC percentage, primer length, etc. and/or other criteria input by the scientist. For each six primer solution that meets the input criteria, at block 714, process outputs the six primer solution(s) that meet the input criteria. For each six primer solution that does not meet the input criteria, at block 716, process outputs the six primer solution(s) that do not meet the input criteria.

FIG. 9 is a flow diagram of one embodiment of a process 900 to determine a quad-primer solution. In one embodiment, process 900 is executed by process 700 at block 706 above. In FIG. 9, process 900 beings by receiving the P2/P3/P4/P5 degenerate primer set. In one embodiment, this degenerate primer set is one that is calculated from process 700 at blocks 704B-E above. At block 904, process 900 builds a degenerate mesh for primers P4/P5. In one embodiment, a degenerate mesh is a mesh of solutions for primers P4 and P5 that represent a suitable path from P4→P5. For example and in one embodiment, this degenerate mesh is the best path from P4→P5. In another embodiments, the degenerate mesh is one or more suitable paths from P4→P5. Building the degenerate mesh for P4/P5 is further described in FIG. 10 below. For example and in one embodiment, process 900 computes primer paths between P4 and P5, such as paths 858A-C as described above in FIG. 8B.

At block 906, process 900 builds a degenerate mesh for P3/P4 using the results of the P4/P5 degenerate mesh from blocks 904 above. In this embodiment, the degenerate mesh is a mesh of solutions for primers P3 and the P4/P5 degenerate mesh. For example and in one embodiment, the P3/P4 degenerate mesh is the best path from P3→P4→P5. In another embodiments, the degenerate mesh is one or more suitable paths from P3→P4→P5. Building the degenerate mesh for P3/P4 is further described in FIG. 10 below. For example and in one embodiment, process 900 computes primer paths between P3 and the P4/P5 degenerate mesh, such as paths 856A-C as described above in FIG. 8B.

At block 908, process 900 builds a degenerate mesh for P2/P3 using the results of the P3/P4 degenerate mesh from blocks 906 above. In this embodiment, the degenerate mesh is a mesh of solutions for primers P2 and the P3/P4 degenerate mesh. For example and in one embodiment, the P2/P3 degenerate mesh is the best path from P2→P3→P4→P5. In another embodiments, the degenerate mesh is one or more suitable paths from P2→P3→P4→P5. Building the degenerate mesh for P2/P3 is further described in FIG. 10 below. At the end of block 908, process 900 has computed the degenerate mesh for P2/P3/P4/P5. Process 900 returns this degenerate mesh at block 910. For example and in one embodiment, process 900 computes primer paths between P2 and the P3/P4 degenerate mesh, such as paths 854A-C as described above in FIG. 8B.

While in the embodiment illustrated above, the degenerate mesh for the P2/P3/P4/P5 primers was calculated starting from a P4/P5 degenerate mesh and a P3/P4 degenerate mesh, in alternate embodiments, the P2/P3/P4/P5 degenerate mesh can be calculated in different ways. For example and in one embodiment, the P2/P3/P4/P5 degenerate mesh can be calculated starting with a P2/P3 degenerate mesh and a P3/P4 degenerate mesh. In another embodiment, the P2/P3/P4/P5 degenerate mesh can be calculated starting with a P3/P4 degenerate mesh and either a P2/P3 or P4/P5 degenerate mesh.

FIG. 10 is a flow diagram of one embodiment of a process 1000 to build a degenerate mesh. In one embodiment, process 1000 is executed by process 900 at blocks 904, 906, and 908, depending the data that is input to process 1000. In FIG. 10, process 1000 begins by receiving the primer solutions from the degenerate mesh. In one embodiment, process 1000 receives two sets of primer solutions. For example and in one embodiment, process 1000 receives sets of primer solutions for primers P4 and P5. In this embodiment, process 1000 would compute a degenerate mesh for P4/P5 as described above in FIG. 9, block 904.

In another embodiment, process 1000 receives a set of primer solutions and another degenerate mesh. In this embodiment, process 1000 uses the set of primer solutions to extend the inputted degenerate mesh. For example and in one embodiment, process 1000 receives a set of primer solution for the P3 primer and the P4/P5 degenerate mesh as described above in FIG. 9, block 906. Alternatively, process 1000 receives the P2 primer solution set and the P3/P4 degenerate mesh as described above in FIG. 9, block 908. Furthermore, as described above, process 1000 can receive alternate primer solution sets and degenerate meshes.

Process 1000 executes a processing loop (blocks 1004-1016) to find optimal layer 2 primers for each layer 1 primer. In one embodiment, the layer 1 primers are from the first primer solution set and the layer 2 primers are from the second primer solution set or the degenerate mesh that were received at block 1002 above. For example and in one embodiment, the layer 1 primers are from the P4 primer solution set and the layer 2 primers are from the P5 primer solution set. In another embodiment, the layer 1 primers are from the P3 primer solution set and the layer 2 primers are from the P4/P5 degenerate mesh. In a further embodiment, the layer 1 primers are from the P2 primer solution set and the layer 2 primers are from the P3/P4 degenerate mesh. Furthermore, as described above, the layer 1 and 2 primer can be from alternative combinations of primer solution sets and degenerate meshes.

For each primer in the layer 1 primers, process 1000 find compatible layer 2 primers for that layer 1 primer. In one embodiment, process 1000 finds compatible layer 2 primers for the particular layer 1 primer by producing a list of the optimal primer-pair combinations. A primer pair is considered optimal if each of the primers has a low annealing penalty (e.g., using the annealing penalizer described below in FIG. 5, block 508) and the melting temperature of the primers is within a desired threshold (e.g., three degrees).

In one embodiment, process 1000 finds compatible layer 1 and 2 primers by computing a penalty between prospective primers. As is known in the art, there are many different ways known to compute a penalty between possible primers. In one embodiment, process 1000 computes a penalty based on the positive or negative interactions that can occur between the possible primer pairs. For example and in one embodiment, process 1000 computes an inter-primer pair penalty using the annealing penalizer as described above with to FIG. 5A, block 508 above. For example and in one embodiment, process 1000 computes an inter-primer pair penalty using the annealing penalizer as described above with to FIG. 5A, block 508 above.

In one embodiment, process 1000 computes a primer pair penalty for primer pair consisting of primer i and j using Equation (3):

Pᵢⱼ=Pᵢ+Pⱼ+aᵢₙₜₑᵣP(inter)ᵢⱼ (3)

where Pᵢ and Pⱼ are the penalties for primers i and j, respectively, P(inter)ᵢⱼ is the inter-primer penalty calculated between primers i and j, and aᵢₙₜₑᵣ is the weight for the inter-penalty penalty. Inter i

At block 1008, process 1008 find an optimal layer 1 and layer 2 primer pair. In one embodiment, process 1000 performs this step for certain primer pair combinations. For example and in one embodiment, process 1000 finds the optimal layer 1 and layer 2 primers when the layer 1 and 2 primers are the P3 and P4 primers. In this embodiment, P3 and P4 primer would be in the same test tube, so process 1000 penalizes the P3/P4 if there is possible secondary structure formation that could occur. For example and in one embodiment, process 1000 penalizes layer 1 and 2 primers if these primer could form a bulge 550B, symmetric interior loop 550C, asymmetric interior loop 550C, and/or multi-branch loop 550E as described above with reference to FIG. 5B.

At block 1010, process 1000 computes the total penalty from block 1006 and, if present, block 1008 for the layer 1 and 2 primers. Process 1000 further determines if the computed penalty from block 1010 is smaller than a previous best penalty. In one embodiment, the best penalty is a smallest penalty determined. In this embodiment, the result of process 1000 is the best match layer 2 primer for the input layer 1 primer. Furthermore, in this embodiment, if process 1000 determines the computed penalty is greater than the best penalty, process 1000 updates the best penalty at block 1014. In another embodiment, the best penalty is a penalty that is smaller than a threshold penalty. In this embodiment, if the computed penalty is greater than the best penalty, process 1000 adds the primer pair to a list of potential primer pairs. Process 1000 ends the processing loop at block 1016.

In FIG. 7, at blocks 704B-E, process 700 computes degenerate primers that are used to optimize a degenerate quad solution. FIG. 11 is a flow diagram of one embodiment of a process 1100 to build degenerate primers. In FIG. 11, process 1100 begins by receiving the input that is used by process 1100 to build the degenerate primers. For example and in one embodiment, process 1100 receives the primer range for the desired primer, the enzyme that includes ambiguity codes, and the option input are options input by the scientist (salt concentration, DNA concentration, etc.). In one embodiment, the primer range is the length range that the degenerate primers can have from the corresponding boundary of the target or insert. For example and in one embodiment, downstream end of the P2 primer is determined by the upstream end of the target, the upstream end of the P3 primer is determined by the upstream end of the insert, the downstream end of the P4 primer is determined by the downstream end of the insert, and the upstream end of the P5 primer is determined by the upstream end of the target (See, e.g., FIG. 1B above). Once one end of the primer is determined, process 1100 can walk the opposite way of the determined end of the primer to calculate one more primer candidates for that primer.

Process 1100 builds the primers at block 1104. In one embodiment, process 1100 builds the primers using a fixed point generator best of the worst approach as described in FIG. 6, block 606 above. At block 1104, process 1100 adds the enzyme to the primer. In one embodiment, process 1100 adds the enzyme to the primer by eliminating invalid wildcard suffixes for each wildcard replacement. Adding the enzyme to the primer is further described in FIG. 12A below.

Process 1100 filters the primer at block 1106. In one embodiment, process 1100 decides to accept or reject the primer based on the primer statistics generated by the primer generator and the primer options specified by a scientist. Primer filtering is further described in FIG. 12C below.

In block 1104, process 1100 added the enzyme that includes ambiguity codes to the degenerate primer. FIG. 12A is a flow diagram of one embodiment of a process 1200 to add a wildcard enzyme to a primer. In FIG. 12A, process 1200 begins by receiving the primer and wildcard enzyme to filter. In one embodiment, process 1200 receives the primer (e.g., P2-P5 degenerate primers), the enzyme with ambiguity codes, and other primer characteristics (e.g., desired primer melting point range, desired GC content percentage, etc.). In one embodiment, the wildcard enzyme is attached to the input primer. In this embodiment, process 1200 calculates one or more enzymes that is within the inputted design parameters (e.g., melting temperature, GC content percentage, etc.).

In one embodiment, the wild card enzyme includes a number of labels that could represent many different nucleotides. FIG. 12B is a block diagram of one embodiment of a wildcard enzyme. In FIG. 12B, wildcard enzyme 1230 includes an enzyme prefix 1232 that in on the 3′ side of the wildcard range 1234. For example and in one embodiment, the wildcard enzyme prefix 1232 is “GGCC” and the wildcard range is “NNNNN.” In addition, the wildcard enzyme 1230 includes two suffices, an enzyme suffix 1236A that is part of wildcard 1230 and a primer suffix 1236B that is attached to the wildcard enzyme 1230. For example and in one embodiment, the enzyme suffix 1236A is “CCGG” and the primer suffix 1236B is “AAAAAAAAA.”

Process 1200 executes a processing loop (blocks 1204-1218) to calculate an appropriate enzyme for the input primer for each wildcard nucleotide position in the enzyme. For example and in one embodiment, process 1200 would loop over wildcard range 1234, which includes five different positions corresponding to the “NNNNN.” At block 1206, process 1200 adds the smallest suffix to the enzyme. In one embodiment, the nucleotide with the smallest suffix is the nucleotide that will give the smallest contribution to the desired input parameter, such as melting temperature, GC content percentage, etc. For example and in one embodiment, process 1200 adds the largest suffix for the first N position in the wildcard range 1234 and would add a nucleotide that is A or T as this would decrease the GC percentage. In another example, process 1200 would add an GC pair that would increase the melting point temperature.

At block 1208, process 1200 determines if the nucleotide added above is greater than the largest parameter value. For example and in one embodiment, if the added A or T gives the enzyme+primer a GC content that is over the desired percentage, process 1200 would reject this enzyme+primer combination at block 1210. However, if the added nucleotide is below the desired largest parameter value, process 1200 proceeds to block 1212.

Process 1200 adds the suffix with the largest parameter value to the enzyme at block 1212. In one embodiment, the nucleotide with the largest suffix is the nucleotide that will give the smallest contribution to the desired input parameter, such as melting temperature, GC content percentage, etc. For example and in one embodiment, process 1200 adds the largest suffix for the first N position in the wildcard range 1234 and would add a nucleotide that is G or C as this would increase the GC percentage. In another example, process 1200 would add a AT pair would decrease the melting point temperature.

At block 1214, process determines if the nucleotide added above is smaller than the smallest parameter value. For example and in one embodiment, if the added G or C gives the enzyme+primer a GC content that is over the desired percentage, process 1200 would reject this enzyme+primer combination at block 1210. However, if the added nucleotide is above the desired smallest parameter value, process 1200 proceeds to block 1216, where process 1200 adds the enzyme to the return list. The loop ends at block 1218. Process 1200 returns that enzyme list at block 1218.

FIG. 12C is a flow diagram of one embodiment of a process 1250 to filter a primer based on input primer characteristics. In one embodiment, process 1250 decides to accept or reject the primer based on the primer statistics generated by the primer generator and the primer options specified by a scientist. Furthermore, process 1250 retains a count for each type of failure as this information can be useful to a scientist. For example, if 90% of P1 primers were excluded due to temperature constraints, the scientists may decide to pick a different P1 range.

Process 1250 begins by receiving the primer filter input parameters at block 1252. In one embodiment, process 1250 receives the prospective primer and validity parameters that are used to compare to the prospective primer. For example and in one embodiment, the validity parameters are length criteria, enzyme length criteria, GC content, GC clamp, etc.

At block 1254, process 1250 checks the length of the primer to determine if the primer is within the primer length criteria. In one embodiment, a primer is discarded if it does not meet a length criterion. For example and in one embodiment, is the primer length range is between 25 and 35 base pairs and a primer has a length of less than 25 base pair or greater than 35 base pairs, process 1250 would reject this primer. If the primer is within the length criterion, process 1250 proceeds to block 1256. If not, process proceeds to block 1266 and returns an invalid status.

At block 1256, process 1250 checks if the primer is within an enzyme length criterion. In one embodiment, a floating primer will not have an enzyme but a fixed primer will have an enzyme as part of the sequence. In one embodiment, a fixed primer is discarded if the enzyme length is greater than half of the primer length. In a further embodiment, a floating primer may have an enzyme and process 1250 will check the enzyme length as per above. In another embodiment, process 1250 does not check floating primers against this criterion. If the primer is within the enzyme length criterion or the enzyme length criterion does not apply, process 1250 proceeds to block 1258. If not, process 1250 proceeds to block 1266 and returns an invalid status.

At block 1258, process 1250 checks if the primer fails to meet GC content criteria. In one embodiment, GC content is a percentage measure of the number of G or C nucleotides in a sequence. If the primer is within the GC content criteria, process 1250 proceeds to block 1260. If not, process 1250 proceeds to block 1266 and returns an invalid status.

At block 1260, process checks if the primer has a valid GC clamp criteria. In one embodiment, GC Clamp is a heuristic that specifies that the last N nucleotides of a primer must be a G or C nucleotide. If the primer is within the GC clamp criteria, process 1250 proceeds to block 1262. If not, process 1250 proceeds to block 1266 and returns an invalid status.

At block 1262, process 1250 determines is the melting temperature of the primer is within the input range. In one embodiment, process 1250 allows melting temperature values that are within a half degree Celsius of the range are accepted while values outside of this range are rejected. In one embodiment, the melting temperature of a primer is calculated based on the number of hydrogen bonds that can be formed in the primer. For example and in one embodiment, a C-G pair can form three hydrogen bonds and an A-T pair can form two hydrogen bonds. If the primer is within the melting temperature range, process 1250 proceeds to block 1264 and returns a valid status. If not, process 1250 proceeds to block 1266 and returns an invalid status.

As describe above, the processes illustrated in FIGS. 2-12 are used to generate a set of primers that can be used to amplify a region of interest in a DNA strand. In one embodiment, these processes are executed by a computer (such as computer 154 in FIG. 1B). In this embodiment, the computer receives input from a user directly interfacing with the computer 154 or via a remote computer 152. In one embodiment, a user interface is used to input the data used by computer 154 to perform the automated experimental design.

FIGS. 13-18 are block diagrams of embodiments of user interfaces for use with the automated experimental design. FIG. 13 is a block diagram of a user interface 1300 to perform automated experimental design. In one embodiment, user interface 1300 comprises design parameters panel 1302, options panel 1304, target sequence 1306, and construct sequence 1308. In one embodiment, the design parameters panel 1302 includes an input box to input the start and end of the P1 and P6 regions, input boxes to input the P2/P3 and P4/P5 enzymes, and checkboxes to determine if the P1 and P6 region should mirror range and if the P2/P3 and P4/P5 enzymes should be mirrored enzymes. Furthermore, there is an input box to identify the gene of interest start and end. In the top part of the design parameters panel 1302, the P1-P6 regions as input are displayed.

In one embodiment, option panel 1304 is a series of panels that are used to input different input parameters for the experiment module (e.g. experiment module 158 of FIG. 1B above). For example and in one embodiment, the options panel 1304 includes user interface tabs to allow the input of primary criteria, primer heuristics, primer quality, and southern options. The different components of the options panel 1304 are further described in FIGS. 9-12 below.

In one embodiment, the target sequence panel 1306 is used to input the target DNA strand. While in one embodiment, the target DNA strand is a sequence of IUPAC nucleotide letter codes, in alternate embodiments, the target DNA strand is designated in other ways as known in the art (e.g., NCBI RefSeq, Fasta format, Entrez Gene ID, GenBank ID, or other known gene notations in the art). For example and in one embodiment, the target DNA strand is the strand that is to be modified. In one embodiment, the construct sequence panel 1308 is used to input the construct DNA sequence. For example and in one embodiment, the construct sequence is the sequence that is to be produced.

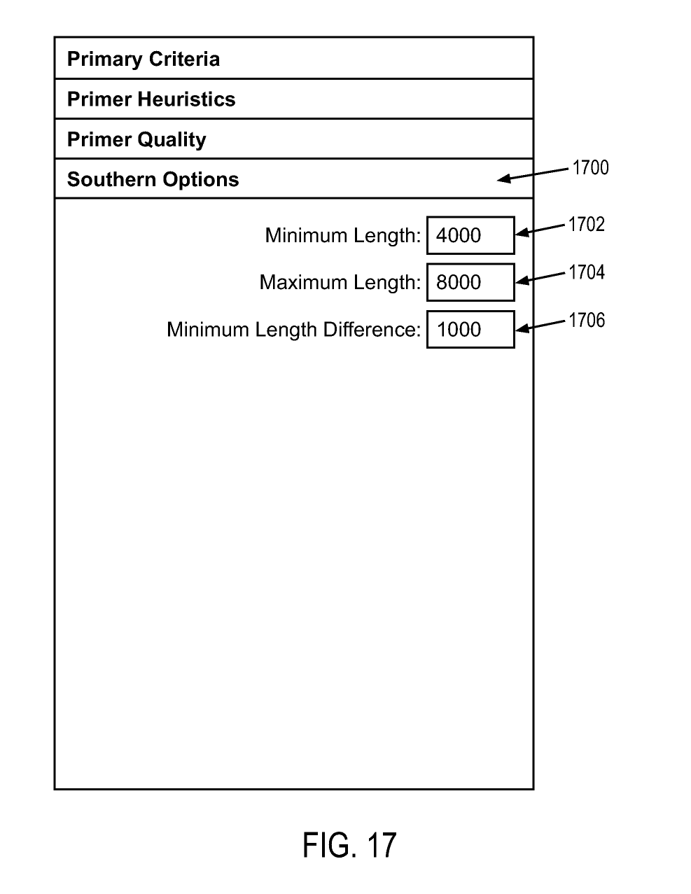

As described above, the options panel 1304 of FIG. 13 is used to input parameters to aid in the primer design. In one embodiment, the options panel 1804 is comprised of one or more different tabs (primary criteria, primer heuristics, primer quality, and southern options, etc.). FIG. 14 is a block diagram of a primary criteria tab 1400 to input primary criteria parameters used for automated experimental design. In one embodiment, primary criteria panel 1400 comprises a salt concentration input box 1402, DNA concentration input box 1404, primer length input box 1406, a GC content slider 1408, a primer temperature slider 1410, and a pair temperature tolerance slider 1412. In one embodiment, the salt concentration input box 1402 is used to input a salt concentration. In one embodiment, the salt concentration affects the melting temperature calculation. In this embodiment, the salt concentration is the molar concentration of sodium ions in the PCR mixture. As is known in the art, sodium is added to the PCR mixture is to stabilize the highly negative phosphates in the DNA backbone. This allows the DNA to unravel and ‘relax’, and essentially buffering interactions with the backbone. In one embodiment, the DNA concentration input box 1404 is used to input a DNA concentration is the molar concentration of primers in the PCR tube and it has a subtle effect on the melting temperature calculation. In one embodiment, the primer length input slider 1906 is used to input a minimum and maximum primer length for a generated primer. For example and in one embodiment, the inputted primer length is used to accept/reject a generated primer as described in FIG. 17, block 1704 above. In one embodiment, the GC content slider 1408 is used to input a minimum and maximum GC content for a generated primer. For example and in one embodiment, the inputted GC content is used to accept/reject a generated primer as described in FIG. 17, block 1708 above. In one embodiment, the primer temperature slider 1410 is used to input a minimum and maximum melting temperature for a generated primer. For example and in one embodiment, the inputted primer temperature is used to accept/reject a generated primer as described in FIG. 17, block 1712 above. In one embodiment, the pair temperature tolerance slider 1412 is used to input a minimum and maximum pair melting temperature tolerance for a pair of generated primers. In one embodiment, the pair temperature tolerance is a difference allowed between the melting points of a primer pair.

FIG. 15 is a block diagram of a primary heuristics tab 1500 to input primary heuristic parameters used for automated experimental design. In one embodiment, the primary heuristics tab 1500 comprises a GC Clamp drop-down box 1502 and Suffix drop-down box 1504. In one embodiment, the GC Clamp drop-down box 1502 is a drop-down box that can enable/disable the GC Clamp feature. The GC Clamp feature, if enabled, excludes primers that do not end with a G or a C. Conversely, disabling the GC Clamp feature 1502 allows primers that do not end with a G or a C. In one embodiment, the suffix drop-down box 1504 that can enable/disable the Suffix feature. The Suffix feature, if enabled, increases the number of fixed primer candidates through suffix variation. For example and in one embodiment, enabling the Suffix feature with a length of 3 can create 64 times as many fixed primer candidates.

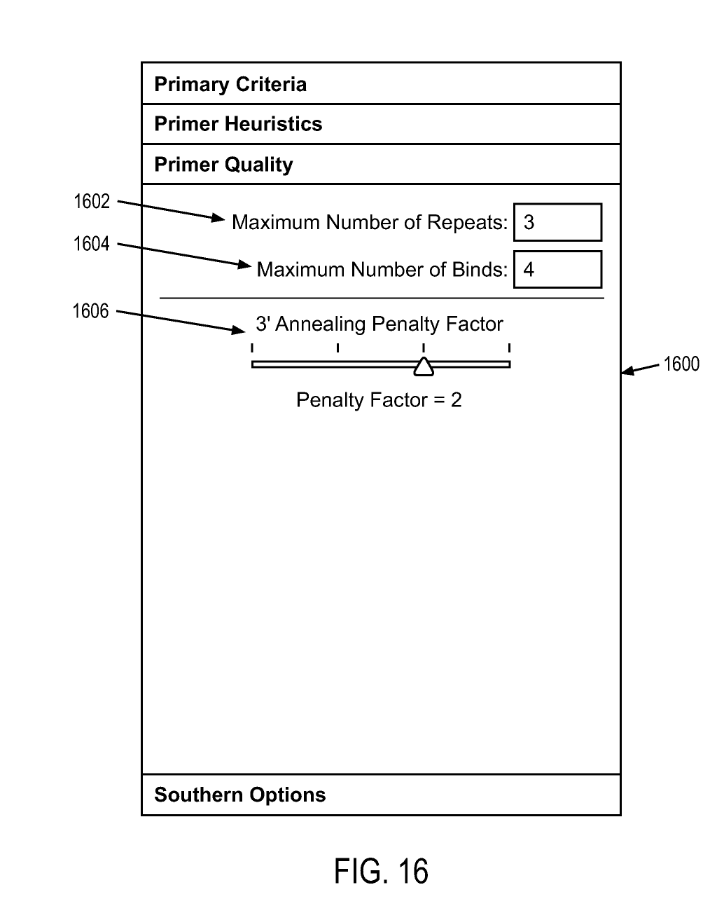

FIG. 16 is a block diagram of a primary quality tab 1600 to input primary quality parameters used for automated experimental design. In one embodiment, the primary quality tab 1600 comprises a Repeats Limit input box 1602, Binds Limit input box 1604, and 3′ Annealing Penalty Factor input box 1606. In one embodiment, the Repeats Limit input box 1602 allows a user to limit the number of nucleotide sequence repeats. For example and in one embodiment, the nucleotide repeats can be one or more nucleotides in a sequence that is repeat up to four or more times. In one embodiment, the Binds Limit input box 1604 limits the total number of binds in the primer. In one embodiment, the 3′ Annealing Penalty Factor input box 1606 allows the scientist to input a penalty that is used to discourage binding that could lead to extension by the polymerase.

FIG. 17 is a block diagram of a southern option tab 1700 to input southern option parameters used for automated experimental design. In one embodiment, the southern options are options that are used to pick another set of primers outside the P1 and P6 primers with some added constraints. In one embodiment, the southern option tab 1700 comprises a minimum length input box 1702, a maximum length input box 1704, and a minimum length difference input box 1706. The minimum length input box 1702 allows a user to specific a minimum length for the extra set of primers. The maximum length input box 1704 allows a user to specific a maximum length for a the extra set of primers. The minimum length difference input box 1706 allows a user to specify the length difference is for the difference between the forward and reverse primer pair.

FIG. 18 is a block diagram of a user interface 1800 that outputs vector design results. In one embodiment, user interface 1800 comprises input panel 1802, options panel 1804, solutions panel 1806, and primary weights panel 1808. The input panel 1802 summarizes the selected input and includes a summary of the gene of interest (start, end, length, initial and ending nucleotide sequence), the input construct is the gene of interest. Furthermore, the input panel can include a summary of the P1 and P6 input range, the left and right enzyme and southern options. The options panel 1804 includes a summary of the options used for the experimental design, such as DNA concentration, salt concentration, primer length range, melting temperature, GC content, pair temperature tolerance, suffix setting, southern length, and southern data minimum.

The solutions panel 1806 includes a set of primers that are a solution for the inputted data. For example and in one embodiment, the solutions panel 1806 includes proposed primers for P1-P6, where for each proposed primer a nucleotide sequence, range where the primer binds to the template, melting temperature, and GC percentage is displayed. In addition, the solutions panel 1806 includes a plot of an overview of primer stats relative to other primers in the pool. Furthermore, the solutions panel 1806 includes a slider that can be used to display different primer solution sets. For example and in one embodiment, the slider can be set to display the best primer solution set, the worst solution set, or one of the solution sets in between.

In one embodiment, the primary weights panel 1808 includes a set of sliders that can be used to set the weights that are used to calculate the primer solution sets. In one embodiment, changing the weights via the sliders can change the relative ranking of the primer solution sets. In this embodiment, a scientist uses these sliders for what the scientist feels is important to their setup. Furthermore, this would be a learned heuristics that may go away with our more accurate modeling of what is important. For example and in one embodiment, a primer solution set that is the best solution with a small weight for a self-annealing penalty, maybe a worse solution if the penalty for self-annealing is increased. In one embodiment, these weights are used to calculate the primer and inter-primer penalties as described in Equations (1) and (3) above. Changing these weights can change the rank order of the primer solution sets.

### PCR PROTOCOL GENERATION

Once a scientist has a set of primers that can be used to amplify a region of DNA, a scientist would design a PCR program, which run on a thermocycler to amplify the area of DNA in order to generate the desired material. In one embodiment, the PCR Protocol Generation module 160 takes the primers and template for each reaction needed (e.g., three total in automated experimental design, four if a scientist chooses verification) and designs a PCR Program (set of instructions for a thermocycler) that optimizes the chance of getting good and specific yield for the desired DNA modification. In one embodiment, the resulting PCR program is optimized based on input reaction reagents that the scientist wishes to use. In another embodiment, the PCR Protocol Module 160 chooses the best reagents and desired concentrations (of all known to us or of a set such as the scientist's inventory) for the given primers and template.

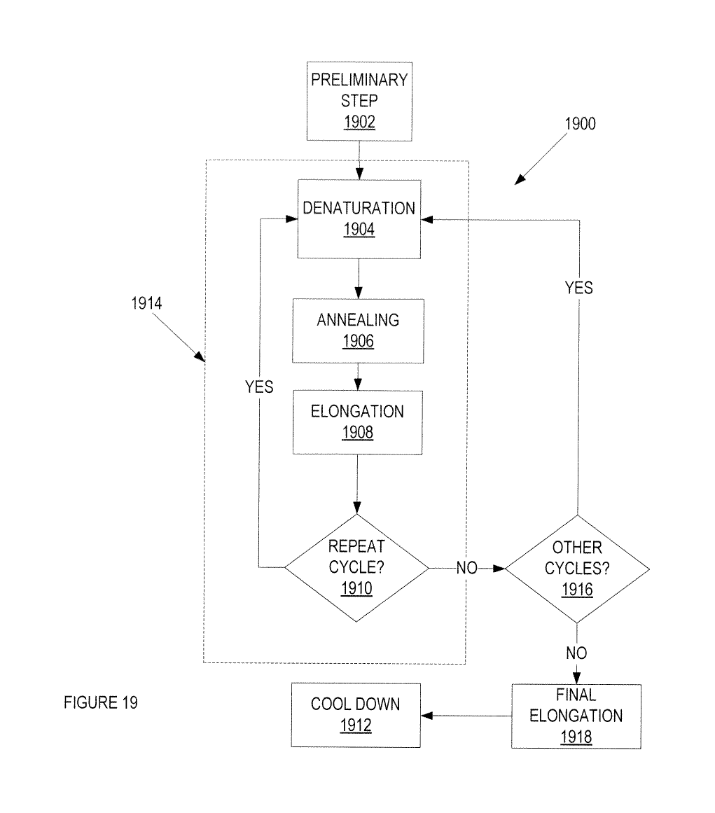

FIG. 19 is a flow diagram of one embodiment of a process 1900 to perform a PCR program. In one embodiment, the basic PCR program consists of four steps: a preliminary step, a series of repeated cycles, a final elongation step, and a final cool down step. At block 1902, process 1900 performs the preliminary step. In one embodiment, the preliminary step is optional depending on the selected reagents. For example and in one embodiment, the preliminary step in PCR is used when there is a heat start polymerase. Heat start polymerases have an antigen attached to them at their active site that denatures and releases at high temperatures, letting the polymerase start to function.

At blocks 1904-1910, process 1900 performs a series of cycles 1914. In one embodiment, the cycle is a set of three steps, each step being perform at a specific temperature and time duration for that temperature. The steps are called denaturation (block 1904), annealing (block 1906), and elongation (block 1908). In one embodiment, the denaturation step (block 1904) consists of heating the reaction mixture to a specific temperature that melts the DNA strand. For example and in one embodiment, process 1900 heats the reaction mixture to a temperature of 94° C. and holding at this temperature for a period of minutes. In one embodiment, the annealing step (block 1906), process 1900 reduces the temperature below the melting temperature of the primers and holds this temperature for a period of time. For example and in one embodiment, process 1900 reduces the temperature to 50-65° C. and holding at this temperature for 20-40 seconds.

In one embodiment, the elongation step (block 1908) consists of increasing the temperature to the active temperature of the polymerase to elongate the target DNA strand. For example and in one embodiment, process 1900 increases the temperature to 70-80° C. and holding at this temperature for a period of minutes.

At block 1910, process 1900 determines if the cycle 1914 is to be repeated. In one embodiment, these three steps of a cycle 1914 are repeated a certain number of times. PCR programs can consist of multiple cycles, but a basic PCR program has just one cycle that repeats 25 to 30 times. If there are no further cycles, at block 1916, process 1900 can determine if other cycles using different parameters are to be performed. In one embodiment, process 1900 determines that a touchdown cycle, step down cycle, or other type of cycles are to be performed as known in the art. In this embodiment, a touchdown or step down cycle alters the annealing temperatures during the annealing steps. If there are other cycles to be performed, execution proceeds to block 1904 above with possible different PCR parameters. If there are no further cycles to be performed, at block 1918, process 1900 performs a final elongation. In one embodiment, the final elongation step is longer than the other elongation step performed. At block 1912, process 1900 performs a cool down. In one embodiment, the temperature of the mixture is cooled down to 4° Celsius using one of the ways known in the art.

In one embodiment, the main variable components of the PCR reaction solution are the buffer used, the polymerase (an enzyme that amplifies the DNA) used, the concentrations of the template DNA primer concentrations, salt and cofactor concentrations. Various polymerases have different active temperatures, different half-lives at certain temperatures, PCR Protocol Generation, different error rates, and a few other unique properties. Various buffers work better or worse for mixes of enzymes and can change the concentrations of various salts, which alter the optimal temperature of the annealing steps for the primers. The concentration of template DNA also can alter the optimum annealing temperature for the primers.

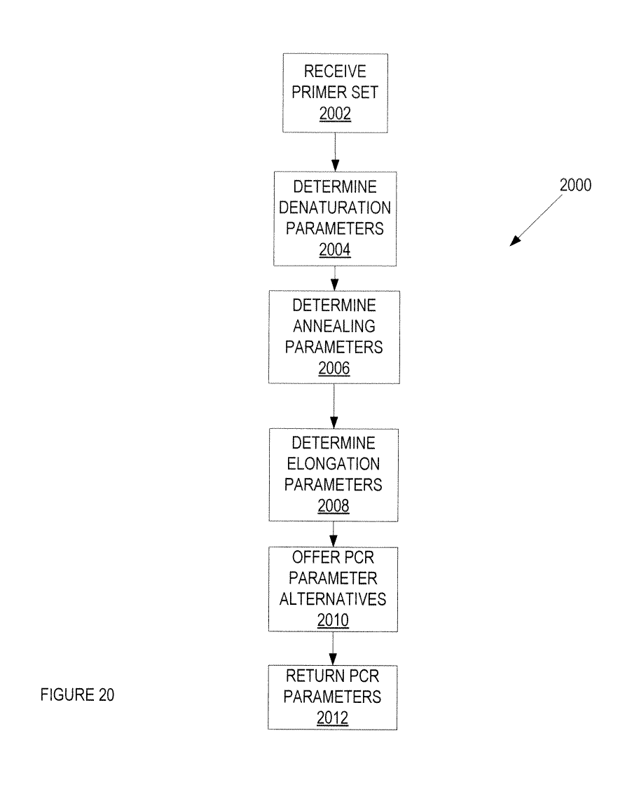

For a scientist to use the PCR program, a scientist need the PCR parameters for each of the steps of the PCR program. FIG. 20 is a flow diagram of one embodiment of a process to generate PCR parameters for the PCR program. In one embodiment, process 2000 receives the type polymerase to be used, buffers, and reagent concentrations used at block 2002. In one embodiment, the parameters of each different PCR steps are set using this information.

At block 2004, process 2000 determines the parameters for the denaturation step. In one embodiment, the denaturation step is generally run at 94° C. and held at this temperature for 30 seconds. In one embodiment, various polymerases have different half-lives at this temperature and the number of effective total cycles can be determined from how long the enzymes spend at this temperature.

At block 2006, process 2000 determines the parameters for the annealing step. In one embodiment, process 2000 determines the annealing step parameters selecting a temperature lower than the lowest melting temperature of the two primers. In one embodiment, the annealing temperature is influenced by the buffers and salt concentrations to be used in the reaction. In one embodiment, process 2000 uses a primer melting temperature that is calculated from the automated experimental design as described in FIG. 2 above. Furthermore, process 2000 selects a time to hold the reaction mixture at the annealing temperature. For example and in one embodiment, the annealing time is generally for 30 seconds.

Process 2000 determines the parameters the elongation step at block 2008. In one embodiment, the elongation step is determined by the active temperature of the polymerase used and the length of the region being amplified along with the effective speed of the polymerase used. For example, if the scientist was using Taq polymerase, the effective speed would be 1 Kb per 60 seconds, so if the region to be amplified (the region between and including the two primers) was 2000 base pairs, the time for the elongation step would be 120 seconds. The active temperature for Taq polymerase is 72 degrees, so that would be the temperature used. Polymerase properties would be stored locally in a database.

In another embodiment, if the polymerase used was a heat-start polymerase, an the optional preliminary step would be used, which would be a temperature heating around 94 degrees for between 1 and 10 minutes, depending on the properties of the polymerase. The final step is always a cool down to 4 degrees to slow any reactions and degradation of the DNA.

At block 1510, process 2000 offer alternatives to the determined parameters. In one embodiment, in addition to the basic PCR design, there are alterations, which could be used to get better yield, reduce unwanted byproducts, or attempt to get a failed PCR to work. In one embodiment, most of these alternations are not determined to be needed until after a PCR experiment has been run and shown to not work as hoped. In this embodiment, a scientist would attempt to alter the program in order to solve existing problems. Many of these problems are due to unwanted secondary binding to the template or other properties of the underlying DNA region. In one embodiment, process 2000 checks this before hand and offer alternative PCR programs to optimize the experiments success the first time. Process 2000 returns the determined and alternative PCR parameters at block 1512. In one embodiment, process 2000 determines different PCR parameters such as a touchdown or step down cycle, change of concentrations, change of buffer, etc. and/or other different parameters as known in the art.

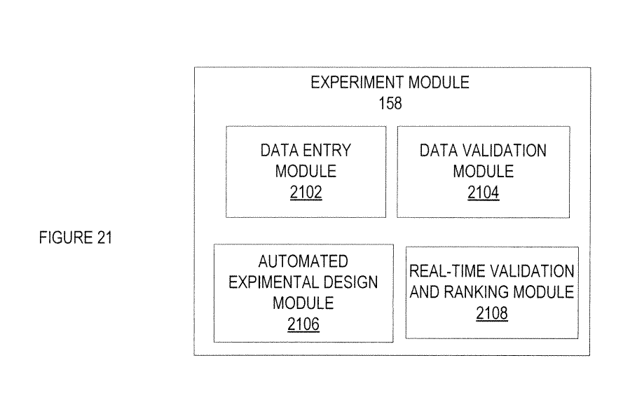

FIG. 21 is a block diagram of one embodiment of an experiment module 158 to perform automated experimental design in designing an experiment. In one embodiment, experiment module 158 comprises data entry module 2102, data validation module 2104, automated experimental design module 2106, and real-time validation and ranking module 2108. In one embodiment, data entry module 2102 receives in experimental entry data as described in FIG. 2, block 202 above. In one embodiment, the data validation module 2104 validates the entry data as described in FIG. 2, block 204 above. In one embodiment, the automated experimental design module 2106 performs automated experimental design as described in FIG. 2, block 206 above. In one embodiment, the real-time validation and ranking module 2108 validates and ranks the results as described in FIG. 2, block 208 above.

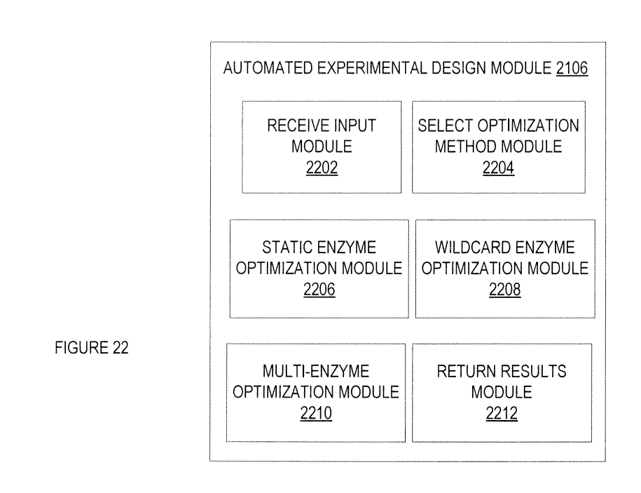

FIG. 22 is a block diagram of one embodiment of an automated experimental design module 2106 to perform automated experimental design. In one embodiment, the automated experimental design module 2106 comprises receive input module 2202, select optimization method module 2204, static enzyme optimization module 2206, wildcard enzyme optimization module 2208, multi-enzyme optimization module 2210, and return results module 2212. In one embodiment, receive input module 2202 receives the input as described in FIG. 3, block 302. In one embodiment, the select optimization method module 2204 selects the optimization method as described in FIG. 3, block 304. In one embodiment, the static enzyme optimization module 2206 performs static enzyme optimization as described in FIG. 3, block 306. In one embodiment, the wildcard enzyme optimization module 2208 performs wildcard enzyme optimization as described in FIG. 3, block 308. In one embodiment, the multi-enzyme optimization module 2210 performs multi-enzyme optimization as described in FIG. 3, block 310. In one embodiment, the return results module 2212 returns the results as described in FIG. 3, block 312.

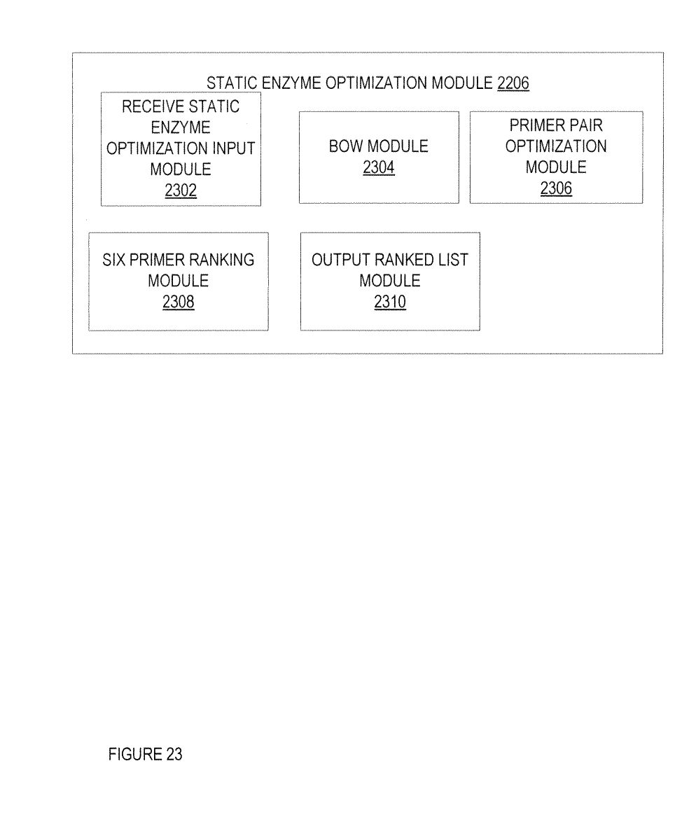

FIG. 23 is a block diagram of one embodiment of a static enzyme optimization module 2206 to perform static enzyme optimization in order to rank six primer solutions. In one embodiment, the static enzyme optimization module 2206 comprises receive static enzyme optimization input module 2302, BOW module 2304, primer pair optimization module 2306, six primer ranking module 2308, and output ranked list module 2310. In one embodiment, the receive static enzyme optimization input module 2302 receives the static enzyme optimization input as described in FIG. 4, block 402. In one embodiment, the BOW module 2304 calculates a list of primers for different primer regions as described in FIG. 4, blocks 404A-F. In one embodiment, the primer pair optimization module 2306 optimizes primer pairs as described in FIG. 4, blocks 406A-C. In one embodiment, the six primer ranking module 2308 ranks six primer solution sets as described in FIG. 4, block 408. In one embodiment, the output ranked list module 2310 outputs a ranked list of six primer solutions as described in FIG. 4, block 410.

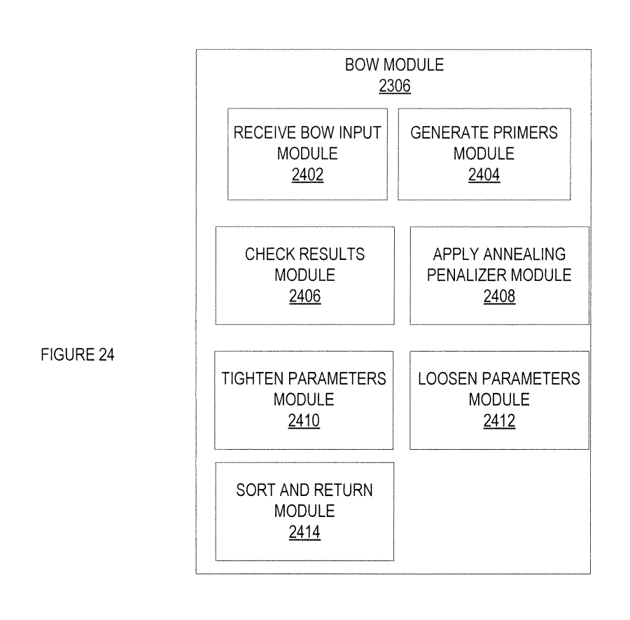

FIG. 24 is a block diagram of one embodiment of a best of the worst module 2306 to use a best of the worst algorithm to generate a number of acceptable solutions for the primer range. In one embodiment, the best of the worst module 2306 comprises receive BOW input module 2402, generate primers module 2404, check results module 2406, apply annealing penalizer module 2408, tighten parameters module 2410, loosen parameters module 2412, and sort and return module 2414. In one embodiment, the receive BOW input module 2402 receives the BOW inputs as described in FIG. 5, block 502. In one embodiment, the generate primers module 2404 generates the primers as described in FIG. 5, block 504. In one embodiment, the check results module 2406 checks the number of generated primers as described in FIG. 5, block 506. In one embodiment, the apply annealing penalizer module 2408 applies the annealing penalizer to the generated primers as described in FIG. 5, block 508. In one embodiment, the tighten parameters module 2410 tightens the BOW parameters as described in FIG. 5, block 510. In one embodiment, the loosen parameters module 2412 loosens the BOW parameters as described in FIG. 5, block 512. In one embodiment, the sort and return module 2414 sorts and returns the generated primers as described in FIG. 5, block 514.

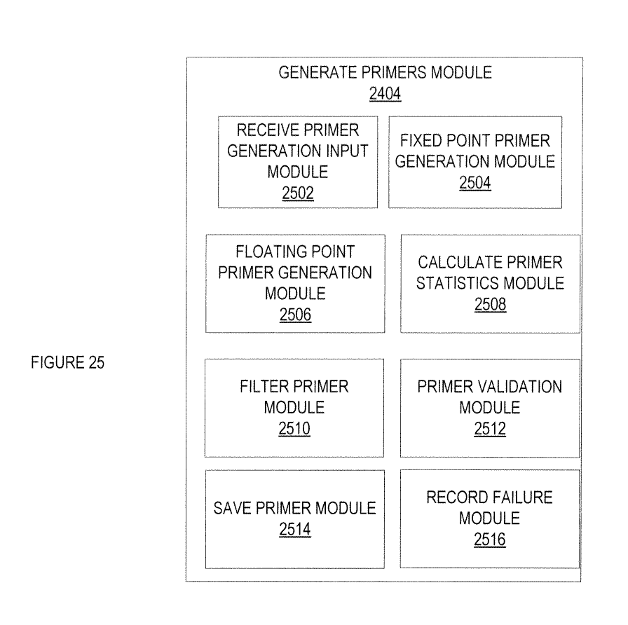

FIG. 25 is a block diagram of one embodiment of a generate primers module 2404 to generate a primer. In one embodiment, generate primers module 2404 comprises receive primer generation input module 2502, fixed point primer generation module 2504, floating point primer generation module 2506, calculate primer statistics module 2508, filter primer module 2010, primer validation module 2012, save primer module 2014, and record primer failure module 2016. In one embodiment, receive primer generation input module 2502 receives the primer generation input as described in FIG. 6, block 602. In one embodiment, the fixed point primer generation module 2504 generates primers at a fixed point as described in FIG. 6, block 606. In one embodiment, the floating point primer generation module 2506 generates primers over a floating range as described in FIG. 6, block 610. In one embodiment, the calculate primer statistics module 2508 calculates the primer statistics as described in FIG. 6, blocks 608 and 612. In one embodiment, the filter primer module 2010 filters the generated primers as described in FIG. 6, block 614. In one embodiment, the primer validation module 2012 checks if the generated primer is valid as described in FIG. 6, block 616. In one embodiment, the save primer module 2014 saves the primer as described in FIG. 6, block 618. In one embodiment, the record primer failure module 2016 records a primer failure as described in FIG. 6, block 620.

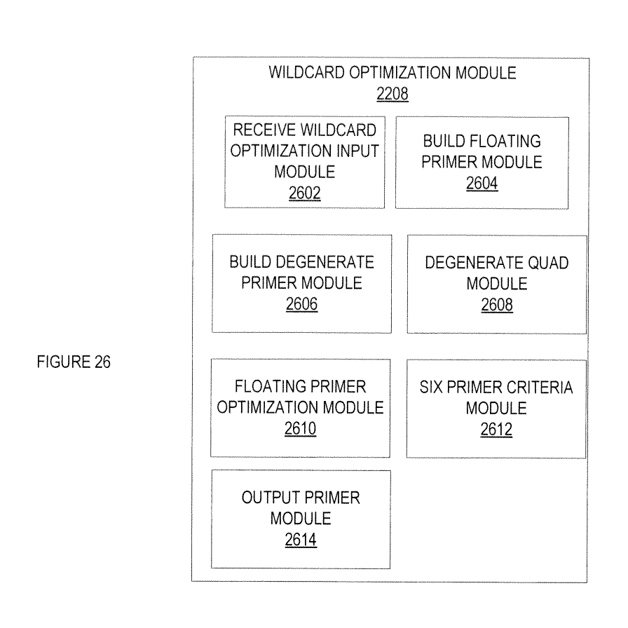

FIG. 26 is a block diagram of one embodiment of a wildcard enzyme optimization module 2208 to perform wildcard enzyme optimization in order to rank six primer solutions. In one embodiment, wildcard enzyme optimization module 2208 comprises receive wildcard optimization input module 2602, build floating primer module 2604, build degenerate primer module 2606, degenerate quad module 2608, floating primer optimization module 2610, six primer criteria module 2612, and output primer module 2614. In one embodiment, the receive wildcard optimization input module 2602 receives the wildcard optimization input as described in FIG. 7, block 702. In one embodiment, the build floating primer module 2604 builds the floating primer as described in FIG. 7, blocks 704A and F. In one embodiment, the build degenerate primer module 2606 builds the degenerate primers as described in FIG. 7, blocks 704B-E. In one embodiment, the degenerate quad module 2608 builds the degenerate quad primers solution set(s) as described in FIG. 7, block 708. In one embodiment, the floating primer optimization module 2610 optimizes the P1 or P6 primer for the quad degenerate solution set(s) as described in FIG. 7, block 710. In one embodiment, the six primer criteria module 2612 determines if the six primer solutions set(s) meet the criteria as described in FIG. 7, block 712. In one embodiment, the output primer module 2614 output the six primer solution set(s) as described in FIG. 7, blocks 714, 716.

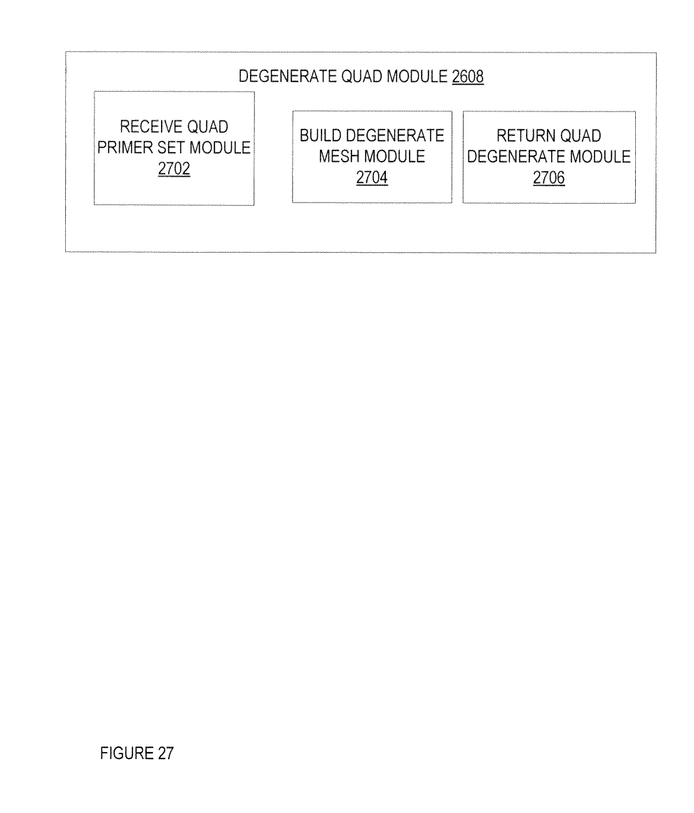

FIG. 27 is a block diagram of one embodiment of a degenerate quad module 2608 to determine a quad-primer solution. In one embodiment, the degenerate quad module 2608 comprises receive quad primer set module 2702, build degenerate mesh module 2704, and return quad degenerate module 2706. In one embodiment, the receive quad primer set module 2702 receives quad degenerate primer set as described in FIG. 9, block 902. In one embodiment, the build degenerate mesh module 2704 builds the degenerate mesh as described in FIG. 9, block 904, 906, and 908. In one embodiment, the return quad degenerate module 2706 returns the quad degenerate mesh as described in FIG. 9, block 910.

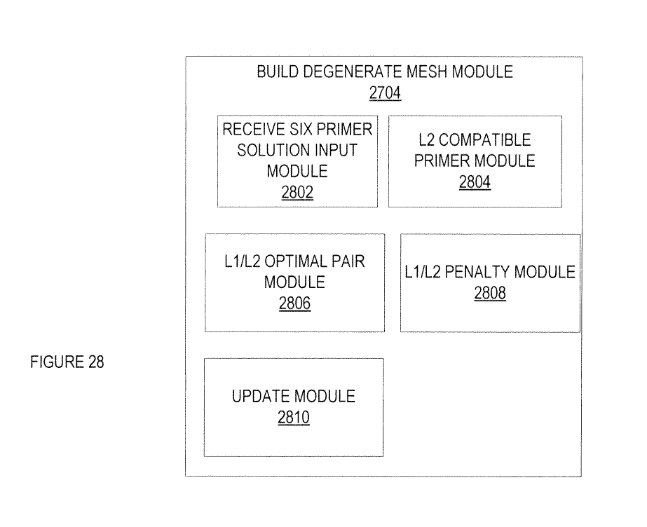

FIG. 28 is a block diagram of one embodiment of a build degenerate mesh module 2704 to build a degenerate mesh. In one embodiment, the build degenerate mesh module 2704 includes receive six primer solution input module 2802, L2 compatible primer module 2804, L1/L2 optimal pair module 2806, L1/L2 penalty module 2808, and update module 2810. In one embodiment, the receive six primer solution input module 2802 receives the six primer solution input as described in FIG. 10, block 1002. In one embodiment, the L2 compatible primer module 2804 find a compatible L2 primer as described in FIG. 10, block 1006. In one embodiment, the L1/L2 optimal pair module 2806 finds an optimal L1/L2 primer pair as described in FIG. 10, block 1008. In one embodiment, the L1/L2 penalty module 2808 computes the L1/L2 primer penalty as described in FIG. 10, block 1010. In one embodiment, the update module 2810 as described in FIG. 10, block 1014.

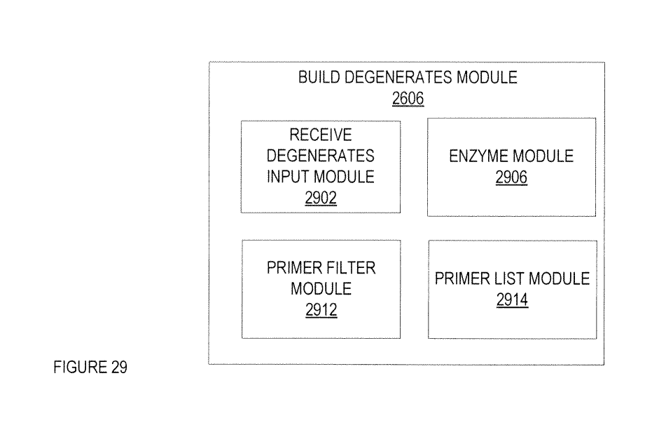

FIG. 29 is a block diagram of one embodiment of a degenerate module 2606 to build degenerates. In one embodiment, the build degenerates module 2606 includes receive degenerates input module 2902, enzyme module 2904, primer filter module 2906, and primer list module 2908. In one embodiment, the receive degenerates input module 2902 receives the degenerate input as described in FIG. 11, block 1102. In one embodiment, the enzyme module 2904 adds the wildcard enzyme to the primer as described in FIG. 11, block 1104. In one embodiment, the primer filter module 2906 filters the primer as described in FIG. 11, block 1106. In one embodiment, the primer list module 2908 adds the filtered primer to the primer list as described in FIG. 11, block 1108.

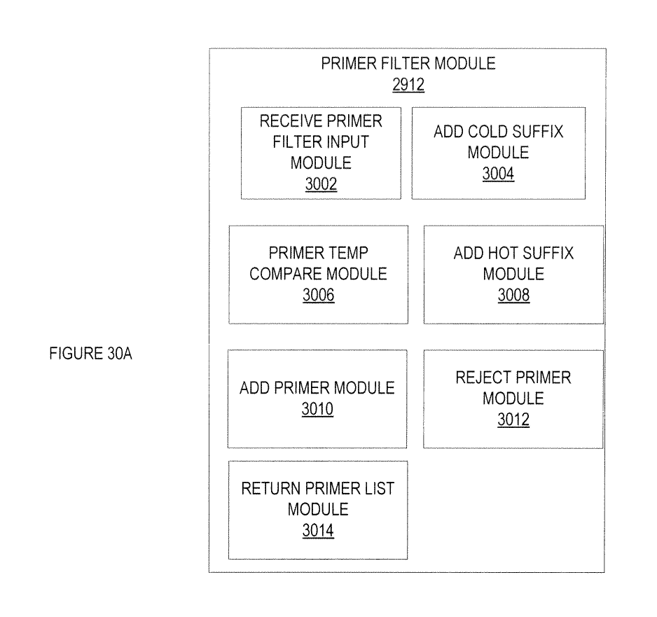

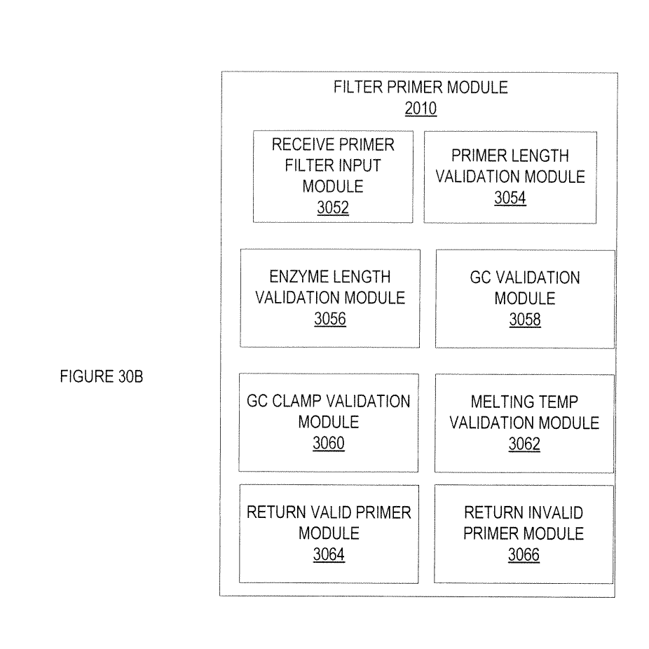

FIG. 30A is a block diagram of one embodiment of a primer filter module 2912 to filter a degenerate primer. In one embodiment, the primer filter module includes receive primer filter input module 3002, add small suffix module 3004, wildcard compare module 3006, add large suffix module 3008, add enzyme module 3010, reject enzyme module 3012, and return enzyme list module 3014. In one embodiment, receive primer filter input module 3002 receives the primer filter input as described in FIG. 12A, block 1202. In one embodiment, the add small suffix module 3004 adds the smallest suffix to the enzyme as described in FIG. 12A, block 1206. In one embodiment, the wildcard compare module 3006 compare the enzyme+primer combination to the criteria as described in FIG. 12A, blocks 1208 and 1214. In one embodiment, the add large suffix module 3008 adds the largest suffix to the enzyme as described in FIG. 12A, block 1212. In one embodiment, the add enzyme module 3010 adds the enzyme to the enzyme return list as described in FIG. 12A, block 1216. In one embodiment, the reject enzyme module 3012 rejects the enzyme as described in FIG. 12A, block 1210. In one embodiment, the return enzyme list module 3014 returns the enzyme list as described in FIG. 12A, block 1220.

FIG. 30B is a block diagram of one embodiment of a primer filter module 2010 to filter a primer based on input primer characteristics. In one embodiment, primer filter module 2010 comprises receive primer filter input module 3052, primer length validation module 3054, enzyme length validation module 3056, GC validation module 3058, GC clamp validation module 3060, melting temp validation module 3062, return valid primer module 3064, and return invalid primer module 3066. In one embodiment, the receive primer filter input module 3052 receives the primer filter input as described in FIG. 12C, block 1252 above. In one embodiment, the primer length validation module 3054 validates the primer length as described in FIG. 12C, block 1254 above. In one embodiment, the enzyme length validation module 3056 validates the enzyme length as described in FIG. 12C, block 1256 above. In one embodiment, the GC validation module 3058 validates the GC content percentage as described in FIG. 12C, block 1258 above. In one embodiment, the GC clamp validation module 3060 validates the GC clamp as described in FIG. 12C, block 1260 above. In one embodiment, the melting temp validation module 3062 validates the primer melting temperature as described in FIG. 12C, block 1262 above. In one embodiment, the return valid primer module 3064 signals a valid primer as described in FIG. 12C, block 1264 above. In one embodiment, the return invalid primer module 3066 signals an invalid primer as described in FIG. 12C, block 1266 above.

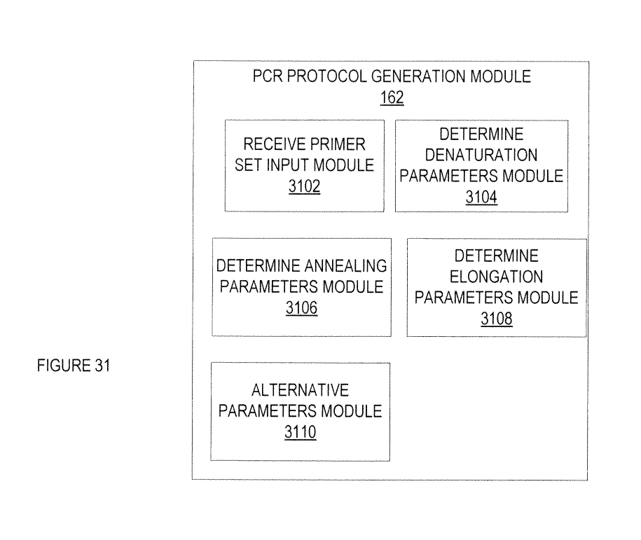

FIG. 31 is a block diagram of one embodiment of a PCR protocol generation module 162 to generate PCR parameters for the PCR program. In one embodiment, PCR protocol generation module 162 comprises receive primer set input module 3102, determine denaturation parameters module 3104, determine annealing parameters module 3106, determine elongation parameters module 3108, and alternative parameters 2210. In one embodiment, the receive primer set input module 3102 receives the primer set input as described in FIG. 20, block 2002 above. In one embodiment, the determine denaturation parameters module 3104 determines the denaturation parameters as described in FIG. 20, block 2004 above. In one embodiment, the determine annealing parameters module 3106 determines the annealing parameters as described in FIG. 20, block 2006 above. In one embodiment, the determine elongation parameters module 3108 determines the elongation parameters as described in FIG. 20, block 2008 above. In one embodiment, the alternative parameters module 2210 calculates alternative PCR protocol parameters as described in FIG. 20, block 1510 above.

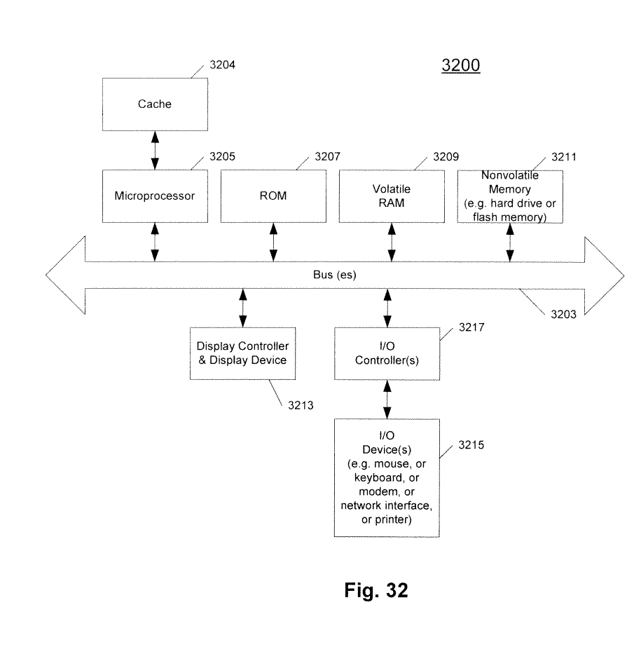

As shown in FIG. 32, the computer system 3200, which is a form of a data processing system, includes a bus 3203 which is coupled to a microprocessor(s) 3205 and a ROM (Read Only Memory) 3207 and volatile RAM 3209 and a non-volatile memory 3211. The microprocessor 3205 may retrieve the instructions from the memories 3207, 3209, 3211 and execute the instructions to perform operations described above. The bus 3203 interconnects these various components together and also interconnects these components 3205, 3207, 3209, and 3211 to a display controller and display device 3213 and to peripheral devices such as input/output (I/O) devices which may be mice, keyboards, modems, network interfaces, printers and other devices which are well known in the art. Typically, the input/output devices 3215 are coupled to the system through input/output controllers 3217. The volatile RAM (Random Access Memory) 3209 is typically implemented as dynamic RAM (DRAM), which requires power continually in order to refresh or maintain the data in the memory.

The mass storage 3211 is typically a magnetic hard drive or a magnetic optical drive or an optical drive or a DVD RAM or a flash memory or other types of memory systems, which maintain data (e.g. large amounts of data) even after power is removed from the system. Typically, the mass storage 3211 will also be a random access memory although this is not required. While FIG. 32 shows that the mass storage 3211 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 3203 may include one or more buses connected to each other through various bridges, controllers and/or adapters as is well known in the art.

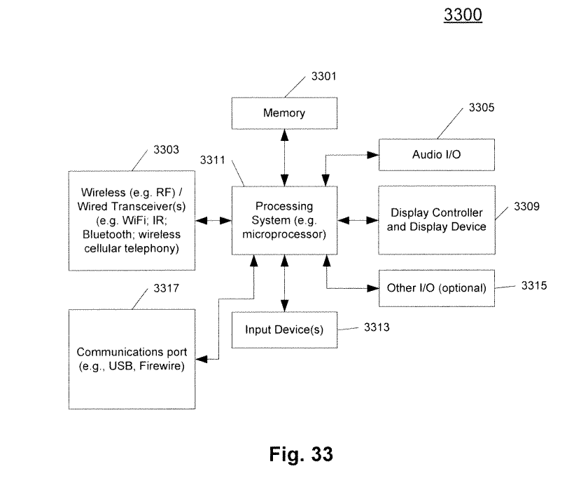

FIG. 33 shows an example of another data processing system 3300 which may be used with one embodiment of the present invention. For example, system 3300 may be implemented as a device 242A-B as shown in FIG. 1. The data processing system 3300 shown in FIG. 33 includes a processing system 3311, which may be one or more microprocessors, or which may be a system on a chip integrated circuit, and the system also includes memory 3301 for storing data and programs for execution by the processing system. The system 3300 also includes an audio input/output subsystem 3305, which may include a microphone and a speaker for, for example, playing back music or providing telephone functionality through the speaker and microphone.

A display controller and display device 3309 provide a visual user interface for the user; this digital interface may include a graphical user interface which is similar to that shown on a Macintosh computer when running OS X operating system software, or Apple iPhone when running the iOS operating system, etc. The system 3300 also includes one or more wireless transceivers 3303 to communicate with another data processing system, such as the system 3300 of FIG. 33. A wireless transceiver may be a WLAN transceiver, an infrared transceiver, a Bluetooth transceiver, and/or a wireless cellular telephony transceiver. It will be appreciated that additional components, not shown, may also be part of the system 3300 in certain embodiments, and in certain embodiments fewer components than shown in FIG. 33 may also be used in a data processing system. The system 3300 further includes one or more communications ports 3317 to communicate with another data processing system, such as the system 3200 of FIG. 32. The communications port may be a USB port, Firewire port, Bluetooth interface, etc.

The data processing system 3300 also includes one or more input devices 3313, which are provided to allow a user to provide input to the system. These input devices may be a keypad or a keyboard or a touch panel or a multi touch panel. The data processing system 3300 also includes an optional input/output device 3315 which may be a connector for a dock. It will be appreciated that one or more buses, not shown, may be used to interconnect the various components as is well known in the art. The data processing system shown in FIG. 33 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 3300 may be a network computer or an embedded processing device within another device, or other types of data processing systems, which have fewer components or perhaps more components than that shown in FIG. 33.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, Calif., a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “determining,” “receiving,” “calculating,” “ranking,” “identifying,” “storing,” “inserting,” “modifying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A computerized method of generating a primer pair design to amplify a target in a DNA template, the method comprising:
calculating a first and second plurality of primers, wherein each primer in the first plurality of primers is from a different region of the DNA template than each primer in the second plurality of primers; and
calculating a first plurality of primer pairs, wherein each of the plurality of primer pairs includes one primer from the first plurality of primers and one primer from the second plurality of primers, and each of the first plurality of primer pairs is calculated based on a penalty of combination between the two primers in that primer pair.

2. The computerized method of claim 1, further comprising:
ranking the first plurality of primer pairs based on the penalty of combination for the each of the first plurality of primer pairs.

3. The computerized method of claim 1, wherein a primer is a piece of genetic material that works in conjunction an enzyme sequence for modifying genetic material of the DNA template.

4. The computerized method of claim 1, wherein the first plurality of primers is composed of fixed primers.

5. The computerized method of claim 1, wherein the first plurality of primers is composed of floating primers.

6. The computerized method of claim 1, further comprising:
calculating a second and third plurality of primer pairs based on a penalty of combination for each primer pairs in the second and third plurality of primer pairs.

7. The computerized method of claim 6, further comprising:
generating a plurality of six primer solution sets from the first, second, and third plurality of primer pairs; and
ranking the plurality of six primer solutions sets.

8. The computerized method of claim 7, further comprising:
generating a polymerase chain reaction protocol parameters based on one of the primer pairs of one of the plurality of six primer solution sets.

9. A computerized method of performing automated experimental design of an experiment to amplify a target in a DNA sequence, the method comprising:
receiving a primer input that is used to perform the automated experimental design;
determining a plurality of possible primers; and
calculating a set of six or more, from the plurality of possible primers, by calculating individual primer penalties for each primer in the set of six or more and inter-primer penalties between pairs of primers in the set of six or more using the primer input, wherein the set of six or more are designed to amplify the target in the DNA sequence.

10. The computerized method of claim 9, wherein each primer in the set of six or more is a piece of genetic material that works in conjunction an enzyme for modifying genetic material of the DNA sequence.

11. The computerized method of claim 9, wherein one primer of the set of six or more is a fixed primer.

12. The computerized method of claim 9, wherein one primer of the set of six or more is a floating primer.

13. The computerized method of claim 9, further comprising:
calculating an enzyme that corresponds to one of the set of six or more.

14. The computerized method of claim 9, wherein the calculating the set of six or more comprises:
determining a set of one or more primer candidates for one of the set of six or more; and
if a number of the set of one or more primer candidates is not within a desired range, adjusting the primer inputs;
calculating a new set of one or more primer candidates for the one of the set of six or more.

15. The computerized method of claim 9, wherein the calculating the set of six or more comprises:
calculating optimal primer pairs using a breadth-first search.

16. The computerized method of claim 9, wherein the inter-primer penalty is based on a degree of interaction between a pair of primers.

17. A computerized method of calculating a primer-enzyme combination, the method comprising:
receiving primer input for the primer;
receiving an enzyme input sequence, wherein the enzyme input sequence is a sequence of nucleotide symbols and at least one of the nucleotide symbols is a ambiguity code;
calculating the primer using the primer input; and
calculating the enzyme that corresponds to the primer using the enzyme input sequence and the primer, wherein the calculated enzyme is the nucleotide sequence of the enzyme input with the ambiguity code is replaced by a non-ambiguity code.

18. The computerized method of claim 17, wherein the primer is a fixed primer.

19. The computerized method of claim 17, wherein calculating the enzyme comprises:
calculating a nucleotide replacement for the ambiguity code from the range of allowed nucleotides for that ambiguity code.

20. The computerized method of claim 19, wherein the calculating a nucleotide replacement comprises:
eliminating invalid replacement nucleotides.
